(19) United States
(12) Patent Application Publication
(10) Pub. No.: US 2002/0007342 A1
(43) Pub. Date: Jan. 17, 2002

(54) Systems and methods for automatically obtaining loss mitigation loan workout decisions

(76) Inventors: Sheila Sellers, Raleigh, NC (US); Marquita Webb, Holly Springs, NC (US); Athanasia Antonopolo, Raleigh, NC (US); Dorothy Mellin, Raleigh, NC (US); Stephanie Galinski, Raleigh, NC (US); Rana Crews, Raleigh, NC (US); R. Greg Perry, Raleigh, NC (US)

Correspondence Address: Peter H. Priest, Esq., Priest & Goldstein, PLLC, 529 Dogwood Drive, Chapel Hill, NC, 27516, US

(21) Appl. No.: 09/788,132

(22) Filed: Feb. 16, 2001

Related U.S. Application Data
(60) Provisional application No. 60/193,546, filed on Mar. 31, 2000.

(51) Int. Cl. G06F 17/60

(52) U.S. Cl. 705/38; 705/35; 705/7

(57) ABSTRACT

Systems and techniques are described for automatically obtaining loan workout decisions. One described system includes a network of personal computers connected into a network administered by a central server computer. Each personal computer in the network includes a network interface for transmitting borrower inputs to, and receiving outputs from, the server computer. Each personal computer in the network further includes display screens for receiving inputs from, and providing outputs to, a financially troubled borrower, including inputs and outputs relating to a proposed workout. The central server computer runs automatic workout decision analysis software and has access to electronically stored information relating to the financially troubled borrower and other information necessary to the decision analysis process. The central server computer transmits to the financially troubled borrower, automatically over the network, approval of the proposed workout if certain predefined parameters are met and, if the predefined parameters are not met, providing further instructions to the financially troubled borrower.

### BACKGROUND OF THE INVENTION

1. Field of the Invention

The present invention relates generally to improvements to systems and methods for applying for loans and particularly to systems and methods for automatically obtaining loss mitigation loan workout decisions.

2. Description of the Prior Art

A mortgage borrower may fall behind on loan payments during periods of financial hardship. In addition to the relief afforded by the bankruptcy laws, a borrower may also seek relief by negotiating a workout with a lender. There are a number of different workout arrangements, ranging from a simple agreement to catch up on delinquent payments by a certain date to deeding the real estate secured by the mortgage to the lender in lieu of payment.

Traditionally, borrowers negotiated workouts with a workout representative or other employee of the lending institution. The process would typically require the borrower to fill out a proposal for a workout, which would then be submitted to the workout representative for review. If more information were required, the workout representative would have to contact the borrower. The workout representative would then have to analyze the workout proposal to determine whether the proposal fell within the workout guidelines established by the lending institution. Thus, the workout process required a significant amount of time on the part of the workout representative. This, in turn, limited the number of workouts that could be negotiated by a lending institution.

There is thus a need for systems and methods for automatically providing workout decisions.

### SUMMARY OF THE INVENTION

The above-described issues and others are addressed by the present invention, one aspect of which provides a system for automatically obtaining loan workout decisions. The system includes a network of personal computers connected into a network administered by a central server computer. Each personal computer in the network includes a network interface for transmitting borrower inputs to, and receiving outputs from, the server computer. Each personal computer in the network further includes display screens for receiving inputs from, and providing outputs to, a financially troubled borrower, including inputs and outputs relating to a proposed workout. The central server computer runs automatic workout decision analysis software and has access to electronically stored information relating to the financially troubled borrower and other information necessary to the decision analysis process. The central server computer transmits to the financially troubled borrower, automatically over the network, approval of the proposed workout if certain predefined parameters are met and, if the predefined parameters are not met, providing further instructions to the financially troubled borrower.

Additional features and advantages of the present invention will become apparent by reference to the following detailed description and accompanying drawings.

### BRIEF DESCRIPTION OF THE DRAWINGS

FIG. 1 shows a diagram of the front end of a system for automatically obtaining workout decisions according to the present invention.

FIG. 2 shows a diagram of a network according to a further aspect of the present invention.

FIG. 3 shows a web page that can be used to access a website on which software components of the present invention are made available over an Internet connection.

FIG. 4 shows a further web page, accessible from the web page shown in FIG. 3, providing access to software components of the present invention.

FIG. 5 shows a home page for software components of the present invention.

FIG. 6 shows a web page containing information relating to a loan for which a workout is sought.

FIG. 7 shows a web page containing data boxes for viewing and modifying information relating to a loan for which a workout is sought.

FIG. 8 shows a web page setting forth Conditions of Approval for a proposed workout.

FIGS. 9A and 9B show first and second pages of an exemplary Approval Letter according to a further aspect of the invention.

FIGS. 10A and 10B show first and second pages of an exemplary Promissory Note according to a further aspect of the invention.

FIG. 11 shows a diagram of a system architecture according to a further aspect of the invention.

FIG. 12 shows a diagram of a flowchart of a method according to a further aspect of the invention. Because of size considerations, FIG. 12 has been divided into a 3×5 matrix, numbered FIGS. 12A1-5, 12B1-5, and 12C1-5.

FIG. 13 shows a diagram of a flowchart of workout methods according to a further aspect of the invention. Because of size considerations, FIGS. 13 has been divided into a 4×3 matrix, numbered FIGS. 13A1-3, 13B1-3, 13C1-3 and 13D-13.

FIGS. 14A and 14B set forth a data matrix that illustrates the data inputs required for the various workouts handles by the e-LMO system and other information relating to the processing these data inputs in accordance with the present invention.

### DETAILED DESCRIPTION

A first aspect of the present invention provides systems and methods for automatically providing workout decisions. According to a first embodiment of the invention, these automatic systems and methods are designed to function in conjunction with a traditional workout process. The automatic systems and methods are used to make decisions on workouts that meet certain predetermined guidelines. If these guidelines are not met, then the traditional workout decision making process is used, in which a full proposal is submitted to a workout representative for review.

The presently described systems and methods are collectively referred to herein as the Electronic Loss Mitigation Optimizer (“e-LMO”) Fast Track. According to a further aspect of the invention, the e-LMO Fast Track is implemented over the Internet or other network, using a web-based interface. The e-LMO Fast Track is accessed remotely by a loan servicer on behalf of a troubled debtor.

At present, workout recommendations from loan servicers are sent to mortgage institutions as a hard copy or as a faxed workout package. This package is subsequently reviewed by a mortgage workout representative. Decisions and negotiated terms are communicated back to the loan servicer by phone and written confirmation. The e-LMO Fast Track system enables a loan servicer to submit workout recommendations over the Internet, or another network connection, with a minimum of data and no hard copy of the workout package. If the mortgage institution's predetermined workout parameters are met, the service will receive automatic approval and an approval letter over the Internet. If the workout parameters are not met, the loan servicer is automatically prompted by the e-LMO Fast Track system to enter additional information or send in a full package for in-house review.

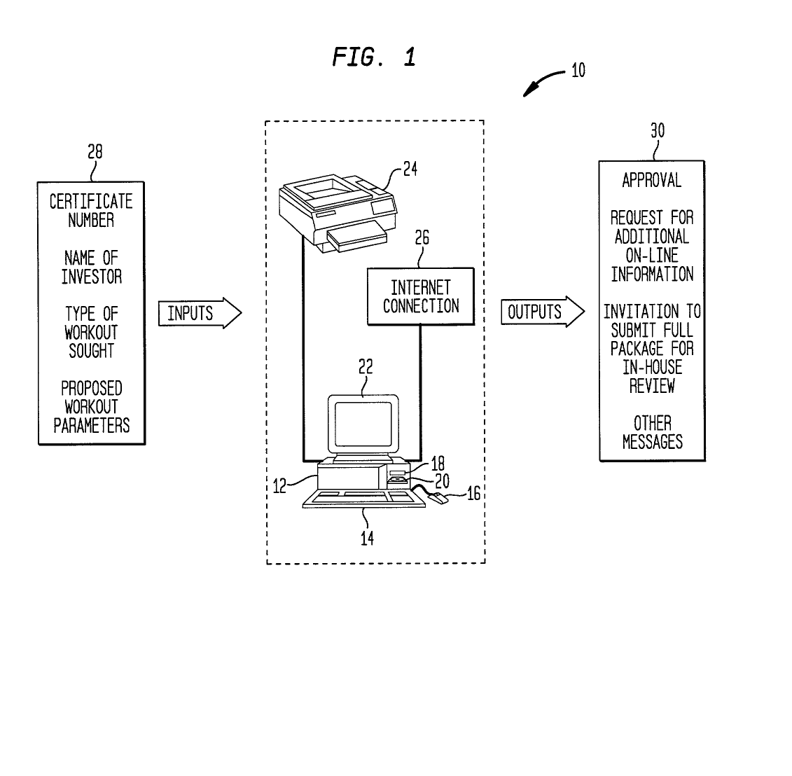

FIG. 1 shows a diagram of the front end of a first embodiment of a system 10 according to the present invention. In this embodiment of the invention, a loan servicer enters inputs concerning the proposed workout into a personal computer 12 or workstation. The personal computer 12 is equipped with suitable input and output devices. In the pictured embodiment, these devices include a keyboard 14, a mouse 16, a diskette drive 18, a CD-ROM drive 20, a monitor 22, and a printer 24. The particular input and output devices used in conjunction with the personal computer 12 may be modified, as needed, without departing from the spirit of the present invention. The personal computer 12 is further provided with an Internet connection 26. As mentioned above, the invention may also be used in conjunction with other types of networks.

As described in further detail below, the e-LMO Fast Track system provides a series of Web pages at the monitor 22 for receiving inputs from, and providing outputs to, the loan servicer. These inputs into the system include information identifying the borrower, as well as information specific to a proposed workout. These inputs are then transmitted over the Internet connection 26 to a central server computer. The central server computer then makes a determination, based upon predetermined parameters, as to whether the proposed workout is acceptable.

The results of the determination by the central server computer are displayed to the loan servicer on the monitor 22. If the proposed workout is approved, an approval screen is displayed on the monitor. In addition, if desired, an approval letter may be printed out at the printer 24. If, however, it is determined that the parameters have not been met, then the central server computer will either send a request for additional information to be inputted into the system, or request the submission of a full package for in-house review by a workout representative.

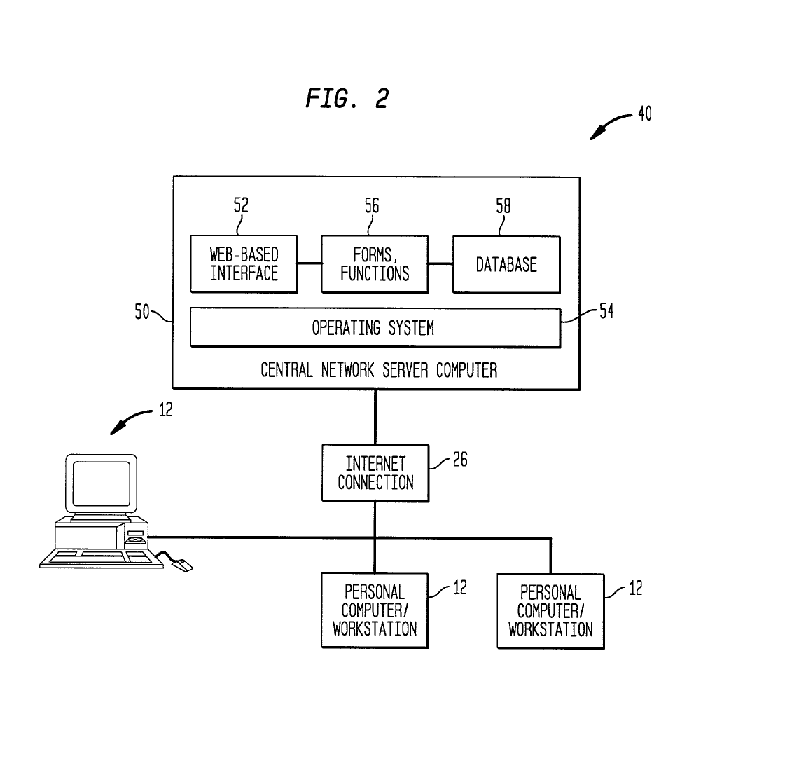

FIG. 2 shows a diagram of an overall network 40 according to a further aspect of the invention. As shown in FIG. 2, the network 40 includes personal computers 12 or workstations, such as the personal computer illustrated in FIG. 1, that are connected via an Internet connection 26 to a central mainframe computer 50 that functions as a network server. The central server computer 50 includes a web-based interface 52, or other suitable network interface, running on a suitable operating system platform 54, such as Windows NT.

In the present embodiment of the invention, the e-LMO Fast Track system is implemented using forms and functions 56 that have been created using a template-based application. These forms and functions 56 are used in the transmission of data between the personal computers 12 in the network and the central network server computer 50. As described below, the forms and functions 56 have access to a database 58 and other information required in determining whether a proposed workout is acceptable.

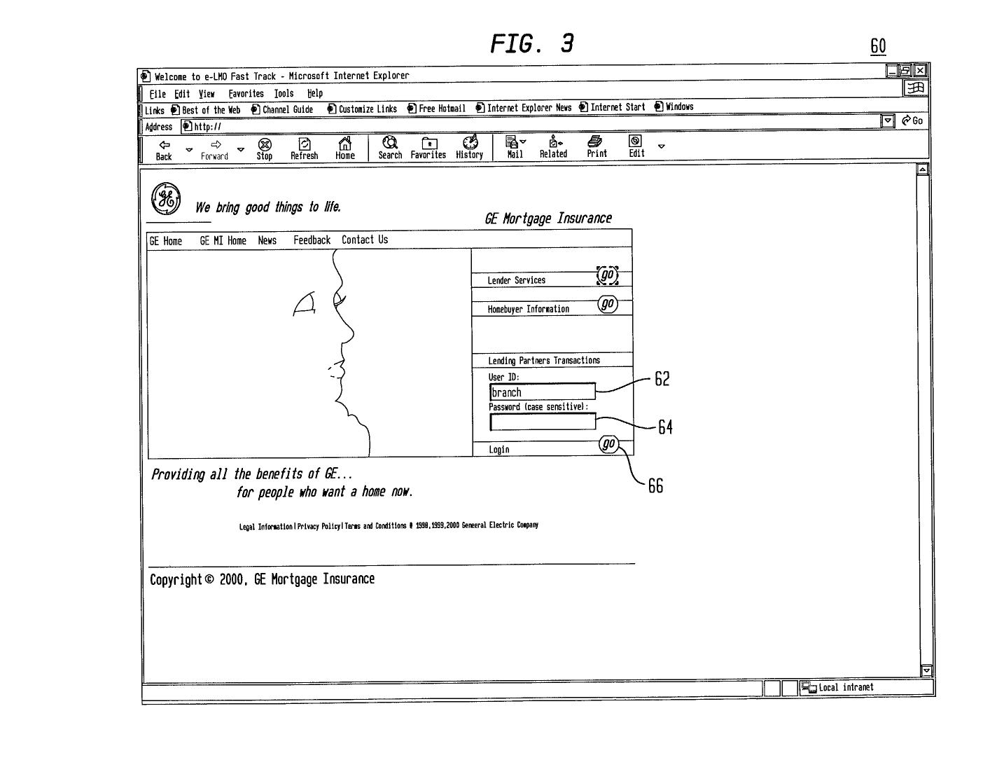

Because, in the present embodiment, the e-LMO Fast Track system is web-based, the system can be accessed using a suitable web browser, such as Internet Explorer or Netscape Navigator, and inputting the correct URL address to arrive at the website at which the e-LMO Fast Track system is located. FIG. 3 shows a screenshot of a login screen 60 that appears when the website is accessed. The loan servicer gains access to the e-LMO Fast Track system by entering a suitable User ID and Password in the boxes 62 and 64 provided, and then clicking on the “Go” button 66.

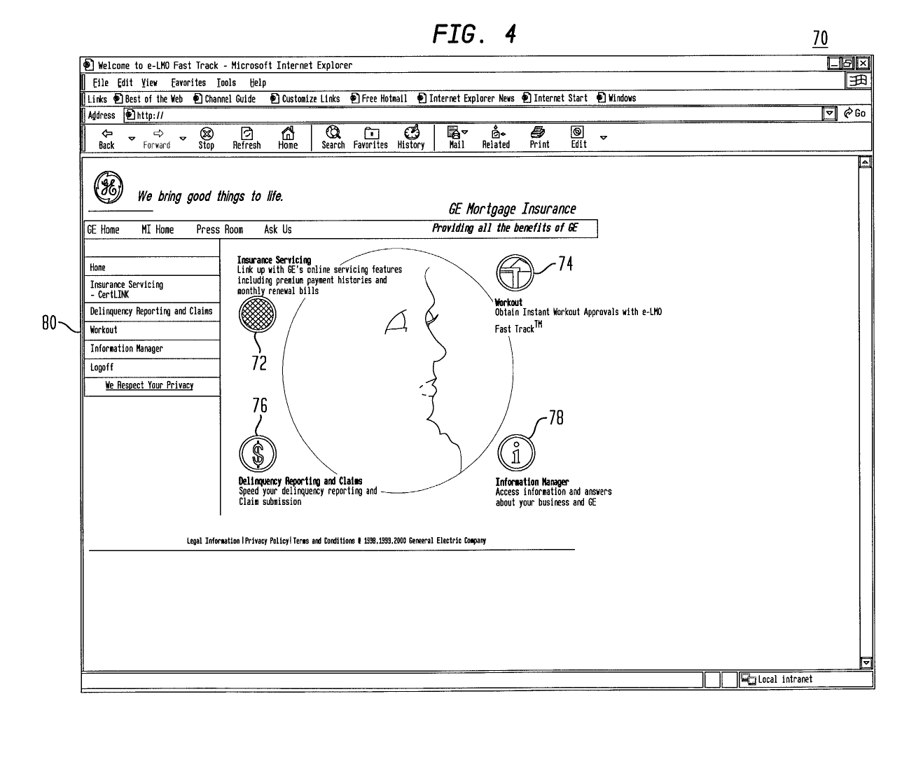

Assuming that the login has been successful, FIG. 4 shows a screenshot of the web page 70 that is accessed by pressing the “Go” button on the FIG. 3 screen. As shown in FIG. 4, this portion of the website includes four services: Insurance Servicing 72, Workout 74, Delinquency Reporting and claims 76, and Information Manager 78.

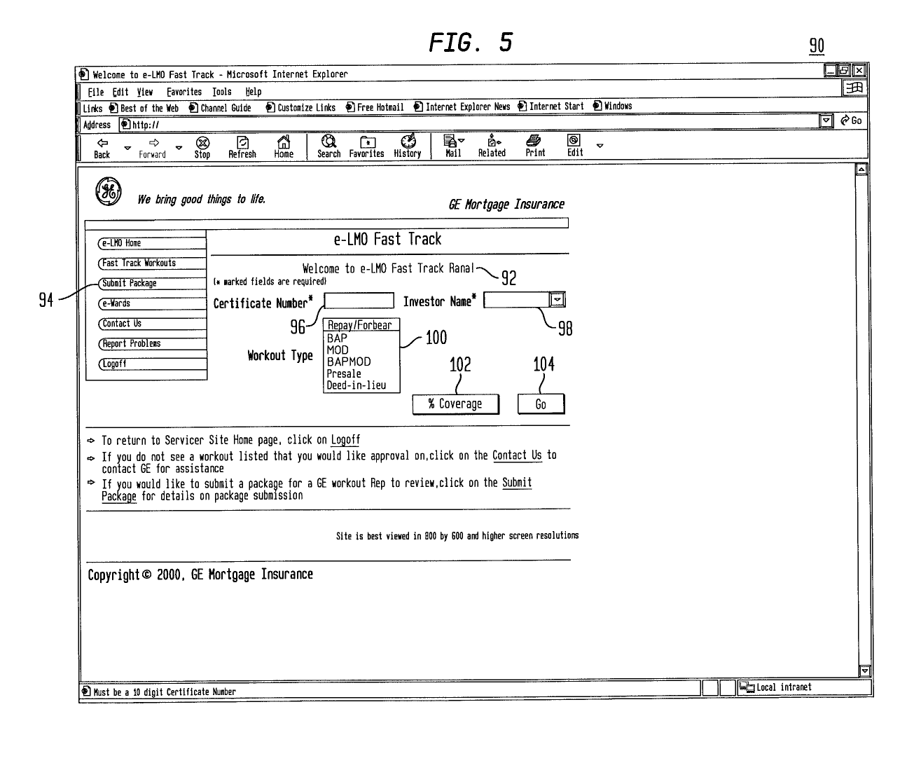

In order to access the e-LMO Fast Track system, the user clicks on the “Workout” button or, alternatively, on the “Workout” box 80 in the navigation bar 82 at the left of the web page 70. Selecting “Workout” brings up the web page 90 shown in FIG. 5. This web page 90 is the home page for the e-LMO Fast Track system. The loan servicer's name appears in the salutation 92 at the top of the page.

At the left of the page, there is a navigation bar 94 containing the following menu entries: e-LMO Home, Fast Track Workouts, Submit Package, e-Wards, Contact Us, Report Problems, Logoff. This navigation bar 94 appears on all of the web pages in the e-LMO Fast Track system to provide a convenient way of navigating between pages. The e-LMO Home button returns the system user to the home page shown in FIG. 5. The Fast Track Workouts button allows the user to look at and work with workouts that are already in the system. The Submit Package button is used when the e-LMO Fast Track system cannot be used for a particular workout and the system user wishes to prepare a fully documented package for consideration by a workout representative. According to a further aspect of the invention, the Submit Package button calls up a web page that provides information relating to the submission of a document-based, hard copy workout proposal to be submitted to a workout representative for approval. The e-Wards button is used to connect to an incentive program, in which a loan servicer accumulates points for each completed workout. These points may subsequently be redeemed for merchandise or other incentive items. The Contact Us button provides a link to an email messaging system that allows the user to email a workout representative. The Report Problems button provides a link to an email messaging system that allows the user to report problems to a technical representative. Finally, the Logoff button allows the user to log out of the e-LMO system.

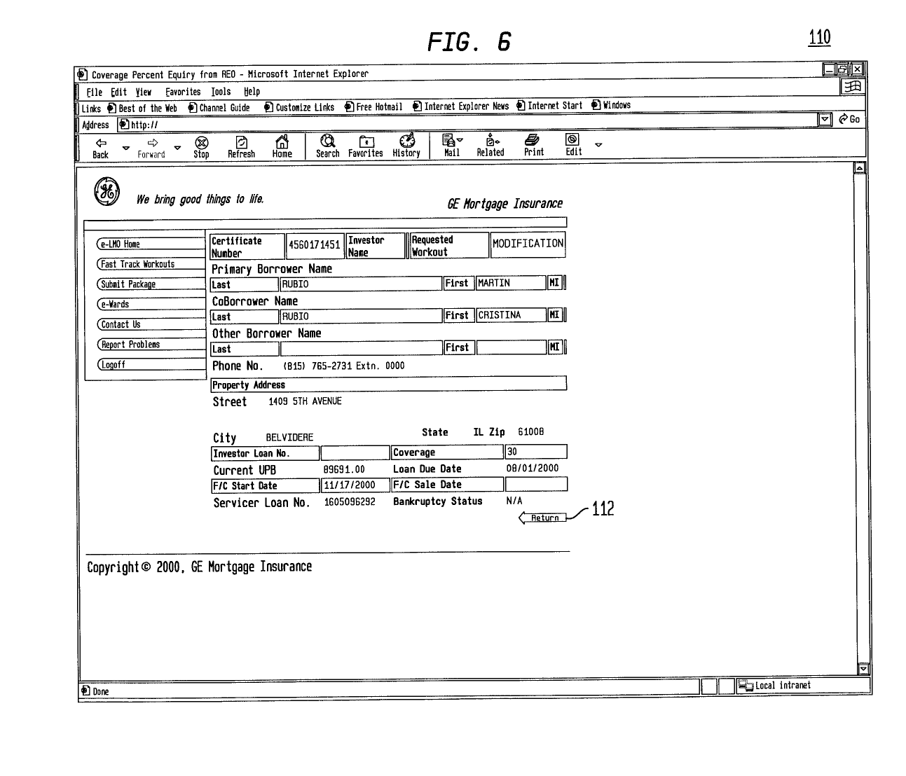

As further shown in FIG. 5, the e-LMO Fast Track home page includes a number of data entry boxes for receiving inputs from the user of the system. These include a box 96 for receiving the Certificate Number of the mortgage insurance policy covering the mortgage for which the workout is being sought, a box 98 for the name of the investor to whom the mortgage was sold on the secondary market, and a box 100 indicating the specific type of workout being sought. In addition, there is a button labeled “% Coverage.” If the loan servicer would like to know the percentage of the mortgage covered by mortgage insurance for a particular loan, the loan servicer enters the Certificate Number and the Investor Name, and then clicks on the “% Coverage” button. Clicking on this button will bring the user to the web page 110 shown in FIG. 6.

As shown in FIG. 6, the “% Coverage” page 110 includes information about the borrower, as well as information about the loan. The loan information includes the Investor Loan Number, Coverage, the Current Unpaid Balance (“UPB”), the Loan Due Date, the Foreclosure (“F/C”) Start Date, the Foreclosure Sale Date, the Servicer Loan Number, and the Bankruptcy Status. Once the review of this information is completed, the user of the system clicks on the “Return” arrow 112 to return to the home page 90, shown in FIG. 5. Alternatively, the user may also use the navigation bar 94 to go directly to other pages in the website.

Returning to FIG. 5, it will be seen that the present embodiment of the invention provides for six basic types of workouts that can be handled using the e-LMO Fast Track system: Repay/Forbear, Borrower Assistance Program (“BAP”), Loan Modification (“MOD”), BAP Modification (“BAP MOD”), Pre-sale, and Deed-in-Lieu (“DIL”). Each of these types of work arrangements is described below.

The particular workout arrangement sought in a particular situation depends upon the reason that the borrower has become delinquent in making loan payments. If the borrower's financial hardships are temporary in nature, the borrower may seek simply to arrange to repay the delinquent amounts by a certain date, while keeping the original loan terms intact. If the borrower's financial hardship are permanent, then the borrower may seek a modification of the loan terms, or may even sell or give up the financed real estate as part of the settlement of the outstanding amounts.

The present invention provides for the following scenarios:

1. Payment/Forbearance: The borrower has suffered a temporary financial setback, but will soon have the funds to pay back the delinquent amounts owed. The loan servicer and the mortgage insurance company agree to delay foreclosure, and the borrower promises to pay the entire arrearage, or the full debt, by a specific date, in addition to returning to a normal payment schedule.

2. Borrower Assistance Program (“BAP”). The borrower desires to retain the property, but needs time to obtain the funds to pay back the delinquent amounts owed. In this scenario, in order to qualify for a workout using the e-LMO Fast Track System, the borrower must have the desire and the ability to make payments, little or no equity in the mortgage property, and employment or other steady income source to start within 90 days. In a BAP workout, the borrower signs a promissory note, with a term determined by the mortgagee, and with approval by the mortgage investor.

3. Loan Modification (“MOD”). The borrower has experienced a permanent change in his or her ability to make payments, and the facts and circumstances indicate a likely resolution of the delinquency if the loan terms are suitably modified. Specifically, in this type of workout, there is a modification of the interest rate, the type of mortgage product offered, the amount of capitalization of the loan, and/or the term of the loan, to effect a permanent cure.

4. BAP Modification (“BAP MOD”). A previously negotiated BAP may be modified, assuming that certain guidelines have been met.

5. Pre-sale. If the borrower is financially unable to stay in the home, the property may be placed on the market. In that case, a workout arrangement may be negotiated that takes into account the expected sales price of the property.

6. Deed-in-lieu. If the borrower is financially unable to make up the delinquent payments or to resume regular loan payments, another option is for the borrower to negotiate a workout arrangement that includes deeding the property to the mortgage lender. Obviously, this is a drastic remedy that is typically used only as a last resort.

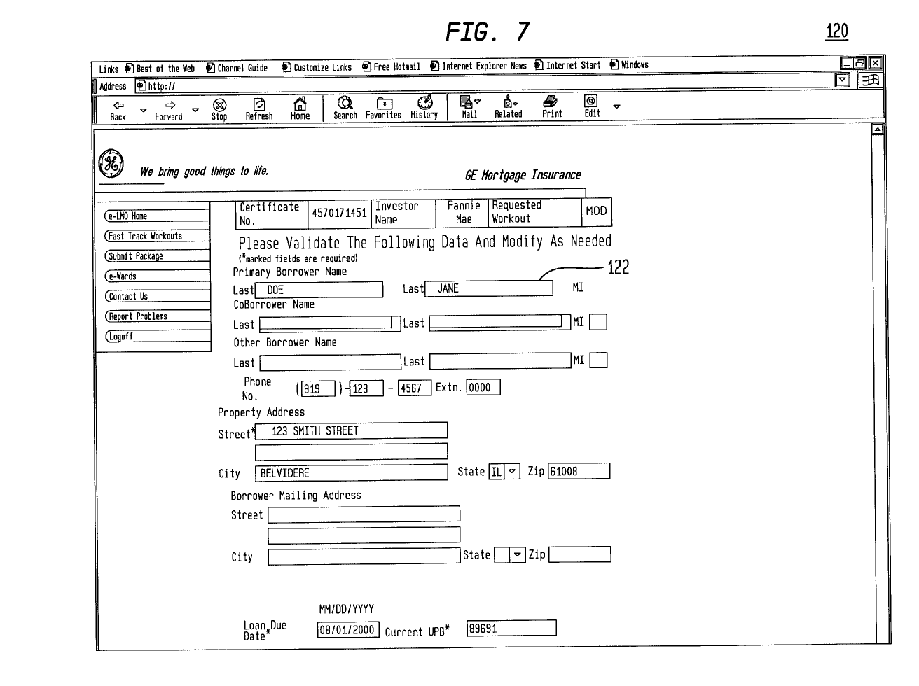

Clicking on one of the options on the menu 100 of workout options shown in FIG. 5 will cause the web page 120 shown in FIG. 7 to appear. The screen includes a number of data entry boxes 122 containing borrower information that has been prefilled by the system, based upon information contained in the mainframe central server. As described below, one of the first steps in the automated workout decision process is to confirm that this information is correct. Corrections are made by making appropriate inputs into the boxes containing the borrower information. When the loan servicer is satisfied that the borrower information is correct, the borrower clicks on a verification button.

Once the borrower information has been verified, the loan servicer or other user of the system is brought to a web page that is designed to receive inputs specific to the type of workout that is being sought. Once those inputs have been entered into the system, the system determines whether the workout satisfies the predetermined guidelines. The system is designed to prompt the lending officer to make changes to the inputted information, as needed. If the lending officer, working with the borrower, is unable to satisfy the e-LMO Fast Track guidelines, the system invites the lending officer to submit a full workout package to a workout representative for review.

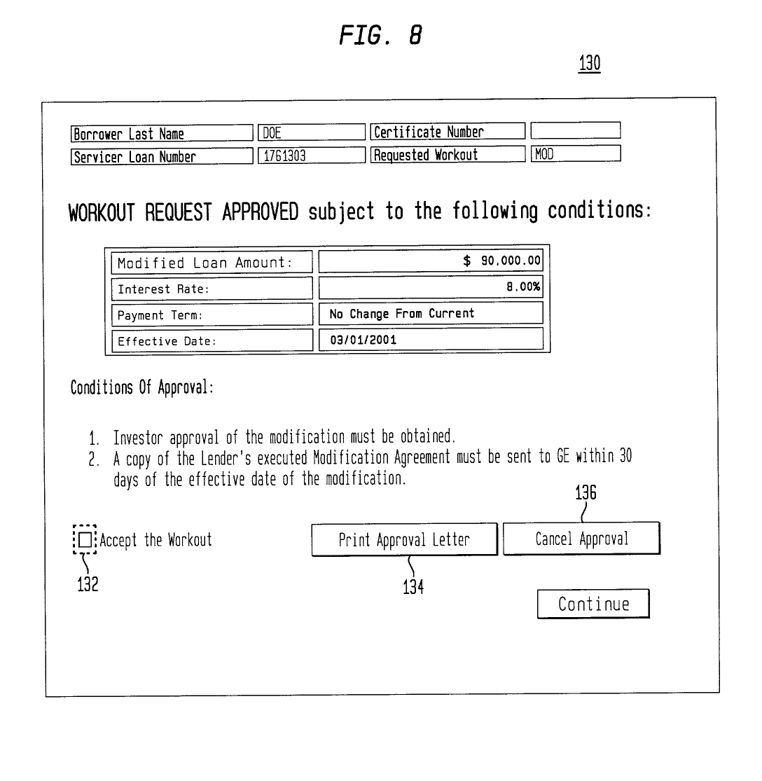

If the workout is approved, then the page 130 shown in FIG. 8 is displayed. This screen states that the workout request has been approved, and sets forth the conditions of approval. These conditions include the modified loan amount, the interest rate, the payment term, the effective date, and the like, and further sets forth conditions of approval.

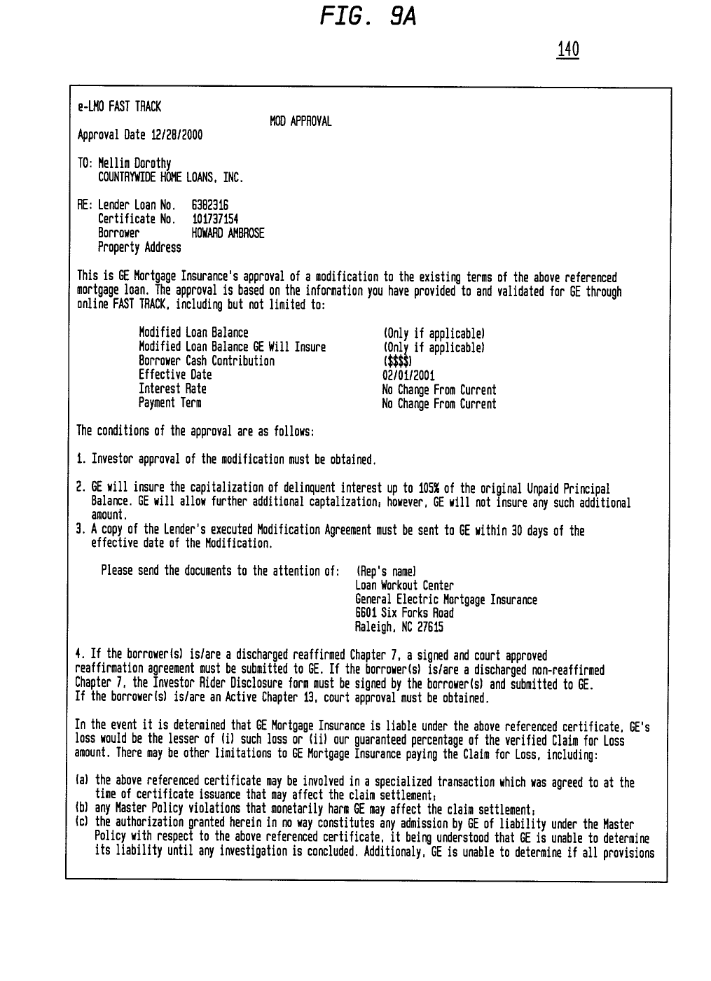

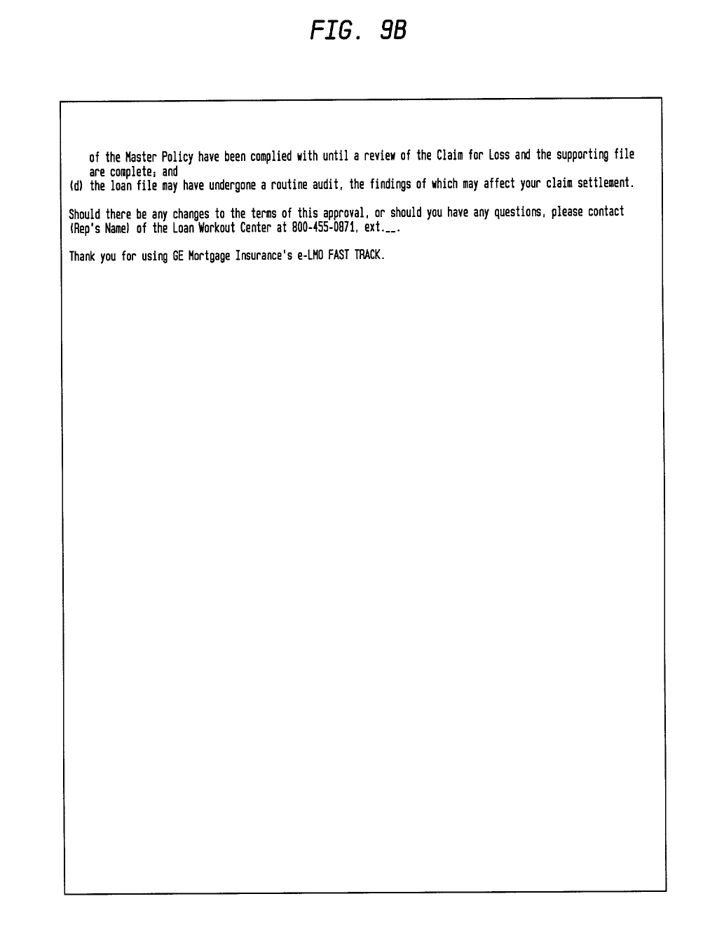

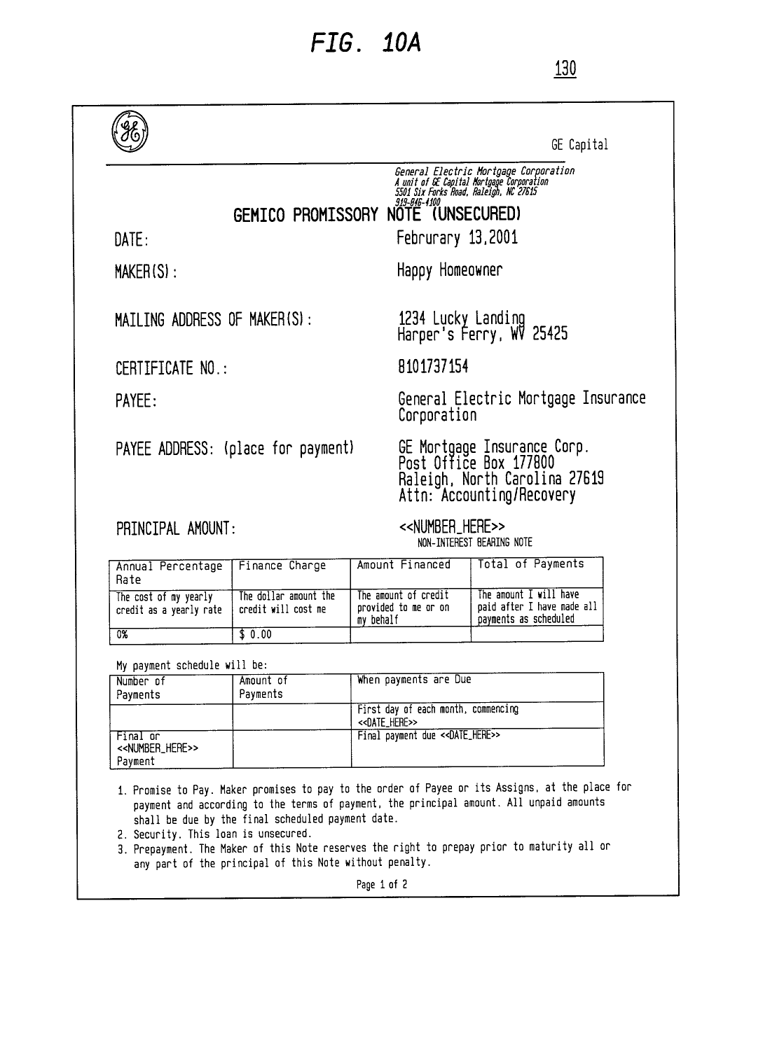

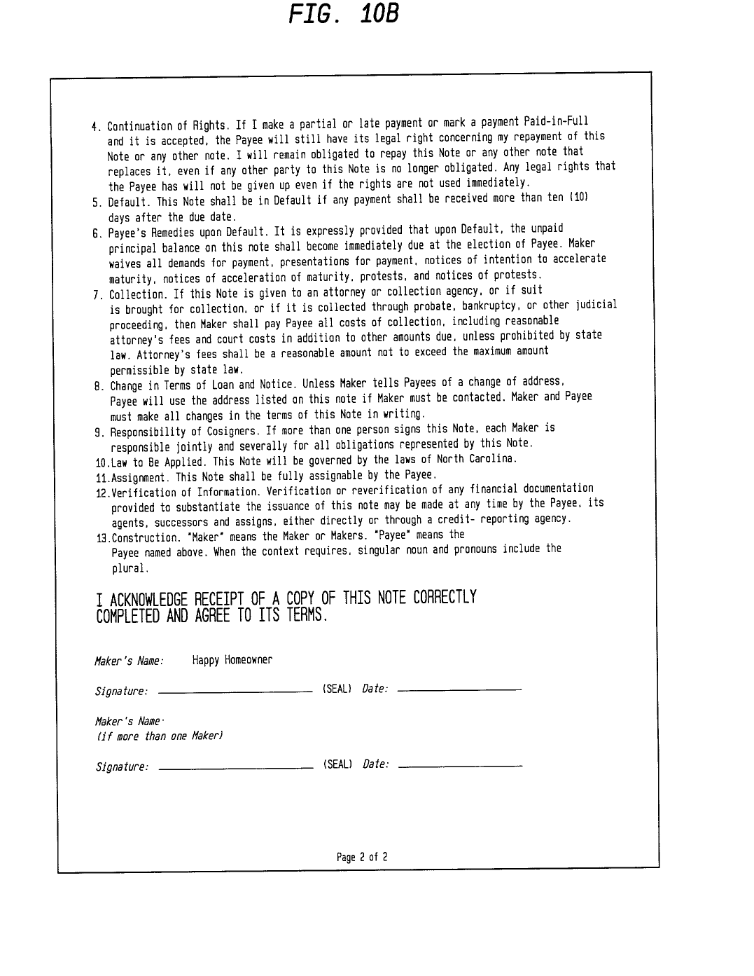

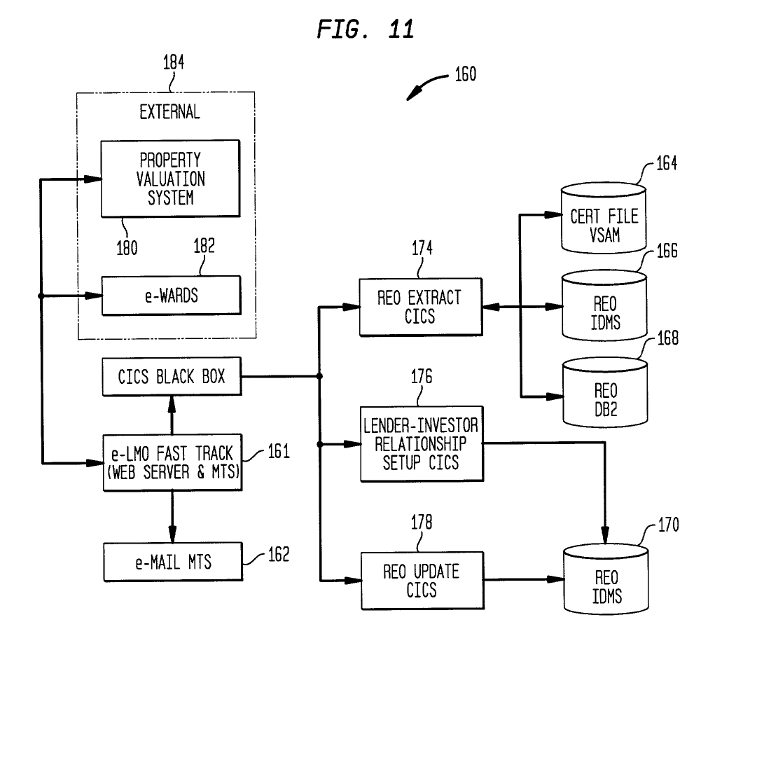

If the borrower accepts the terms of the workout, the user of the system clicks on the button 132 labeled “Accept the Workout.” Also, the user may request the system to print out an approval letter by clicking on the button labeled “Print Approval Letter.” If the user does not wish to accept the workout conditions, the user clicks on the button 136 labeled “Cancel Approval.” The system will also print out a promissory note, as required. An example of an Approval Letter 140 is set forth in FIGS. 9A and 9B. An example of a Promissory Note 150 is set forth in FIGS. 10A and 10B. The terms of the Promissory Note 150 are automatically filled out by the e-LMO Fast Track system.

FIG. 11 shows a diagram of a system architecture 160 according to a further embodiment of the invention. At the core of the system is the e-LMO Fast Track software 161, which is run on a central computer that functions as a web server and also as a Microsoft Transaction Server (“MTS”). The central computer communicates with users of the system using email and MTS 162. The web pages used by the e-LMO Fast Track system may be implemented using Hypertext Markup Language (“HTML”).

In the FIG. 11 embodiment, the various data that are access by the system are stored on suitable storage devices 164-170 using multiple database management systems, including Virtual Storage Access Method (“VSAM”), Integrated Database Management System (“IDMS”), and DB2. One storage device 164 contains the certificate file. The other storage devices 166-170 are used to store other data for the mainframe, referred to herein as the Real Estate Owned (“REO”) mainframe.

A number of Customer Information Control System (“CICS”) interfaces 172-178 are provided between the storage devices 164-170 and the e-LMO Fast Track software 160. These interfaces 172-178 ensure the compatibility of data formats, field requirements, and the like. The CICS interfaces include an REO Extract interface 172 for extracting data from the storage devices, a Lender-Investor Relationship Setup interface 174 for setting up relationships between lenders and inventors, and an REO update interface 176 for updating information in the REO mainframe.

As shown in FIG. 11, the Property Valuation System 180 and e-Wards System 182 are external to the e-LMO Fast Track system and are illustrated as being outside of the firewall 184 However, in an alternative embodiment of the invention, certain components of the Property Valuation System 180 are brought within the firewall for integration into the operations of the REO mainframe.

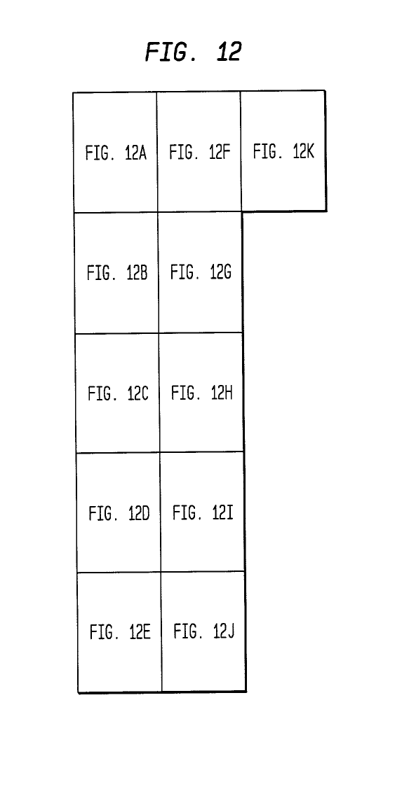

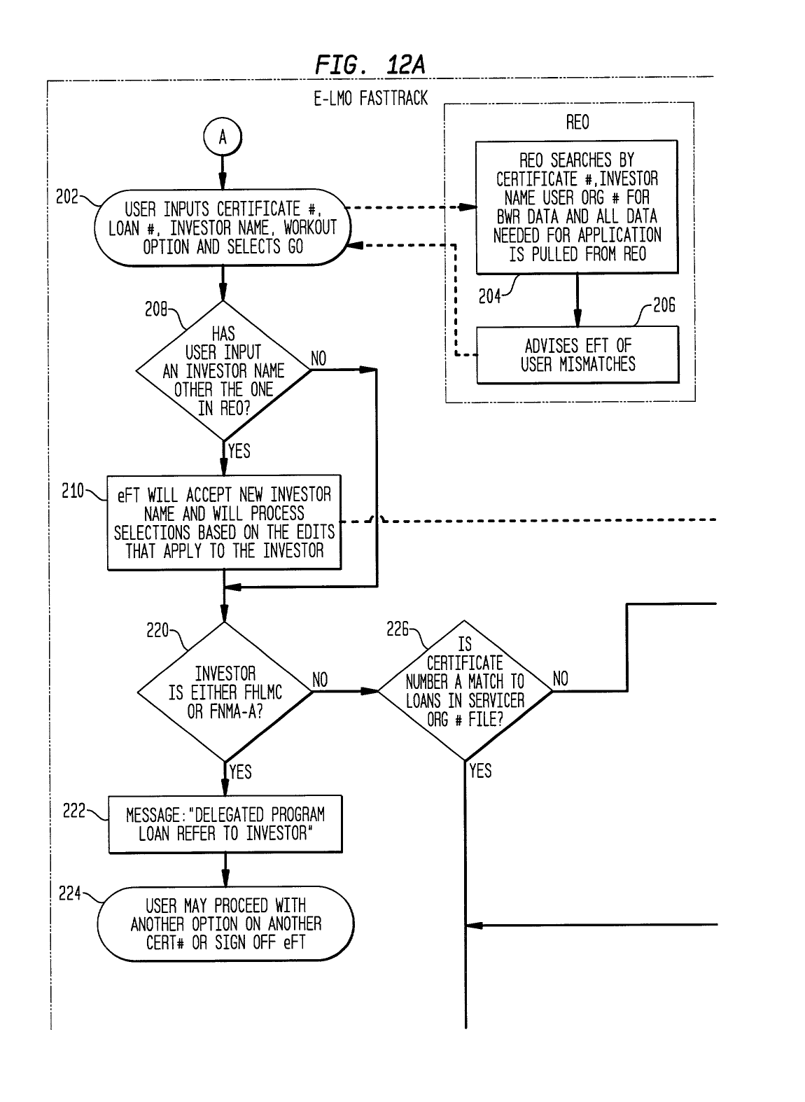

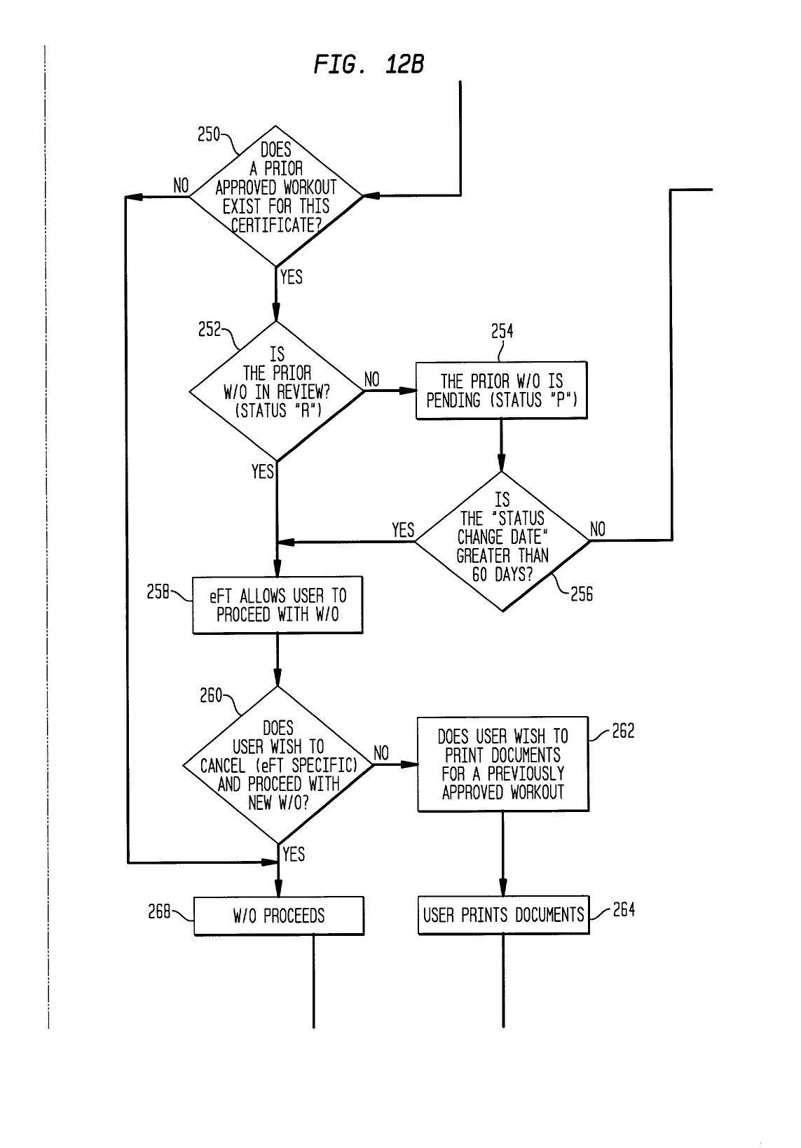

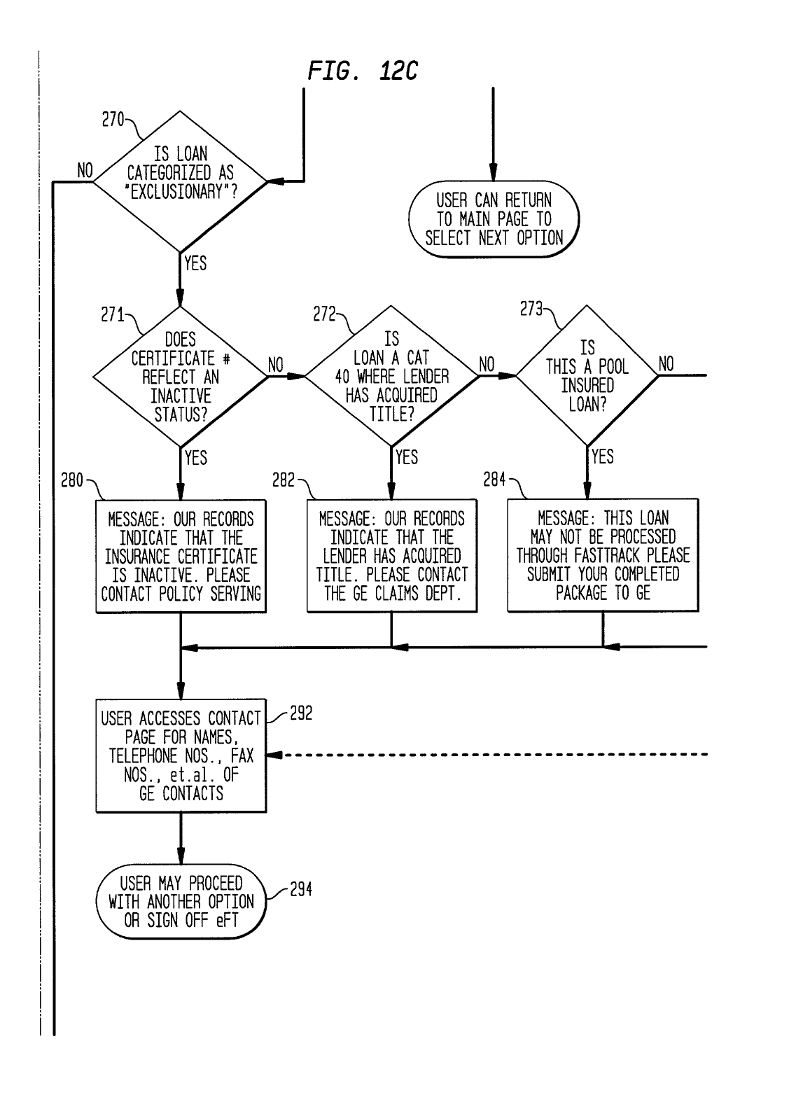

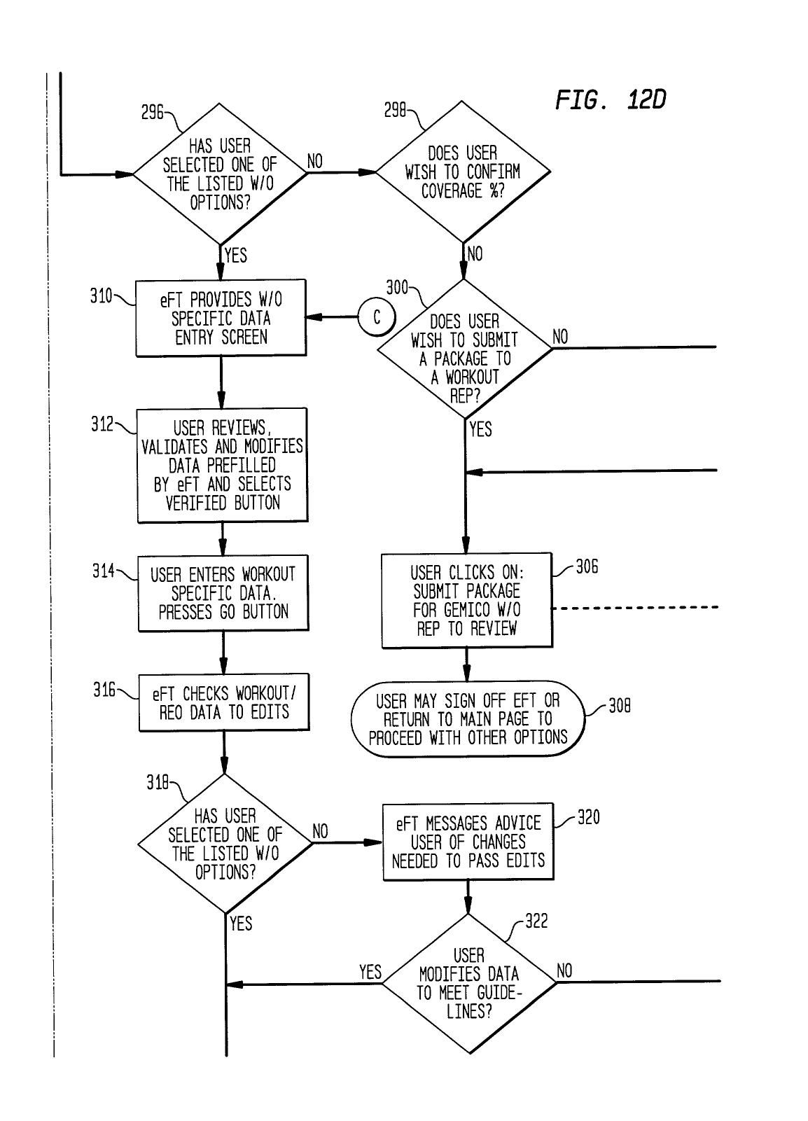

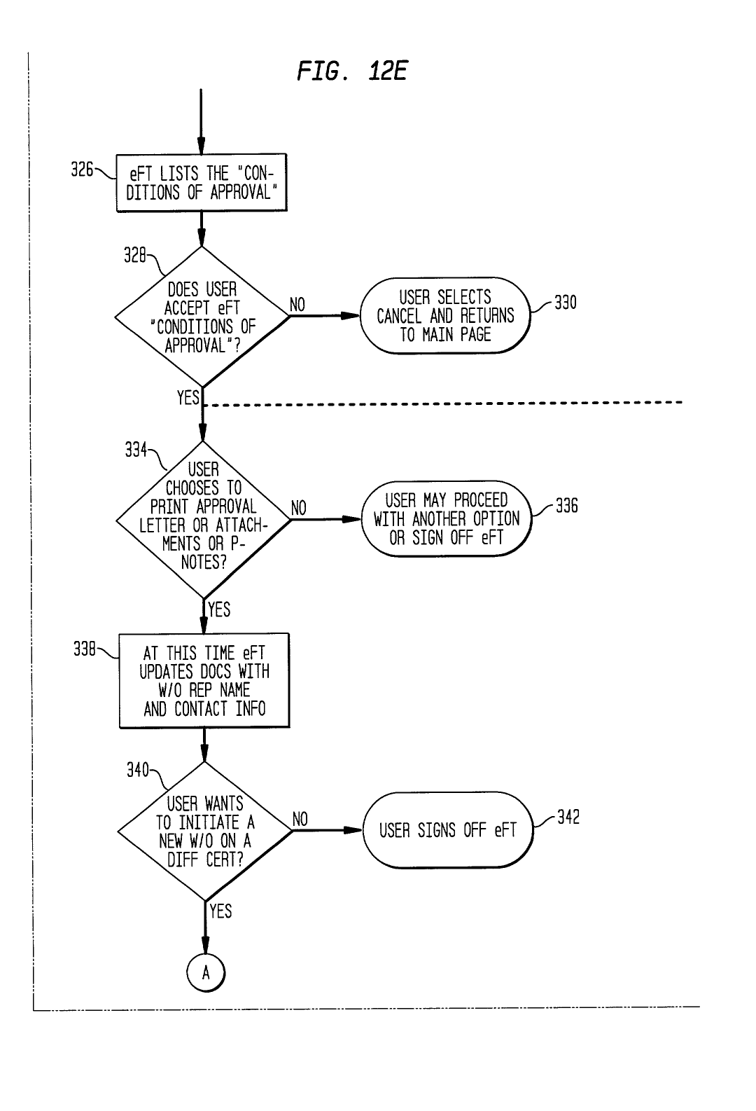

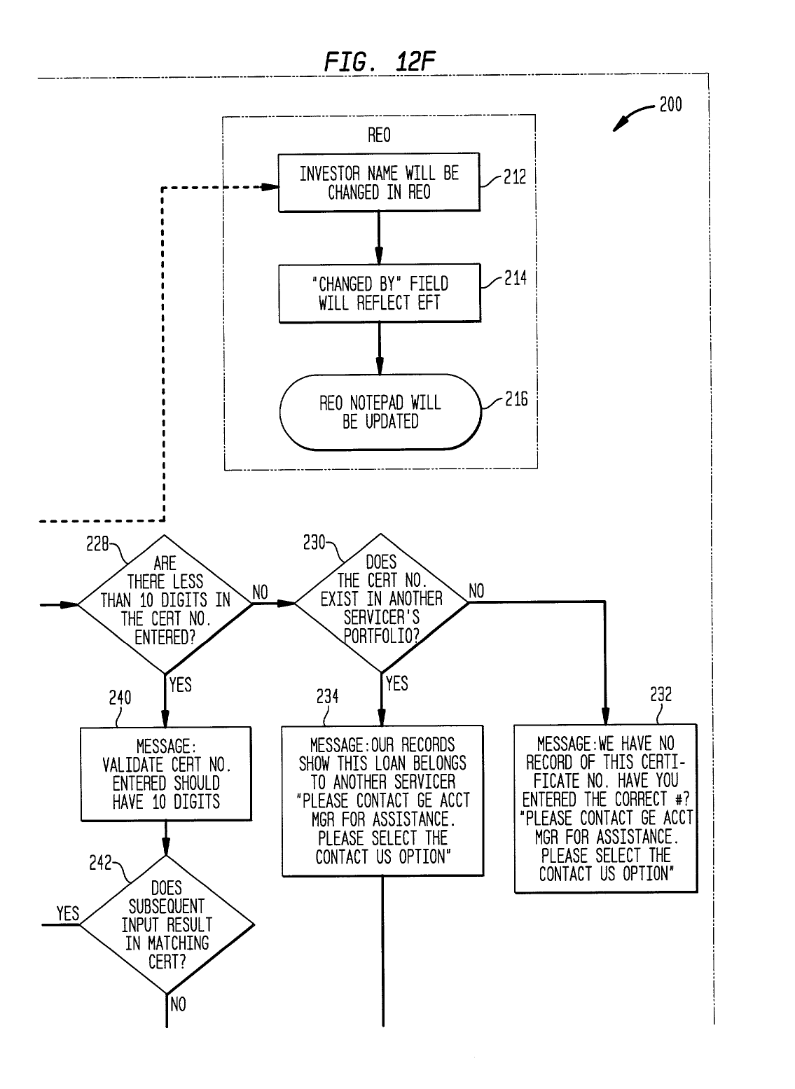

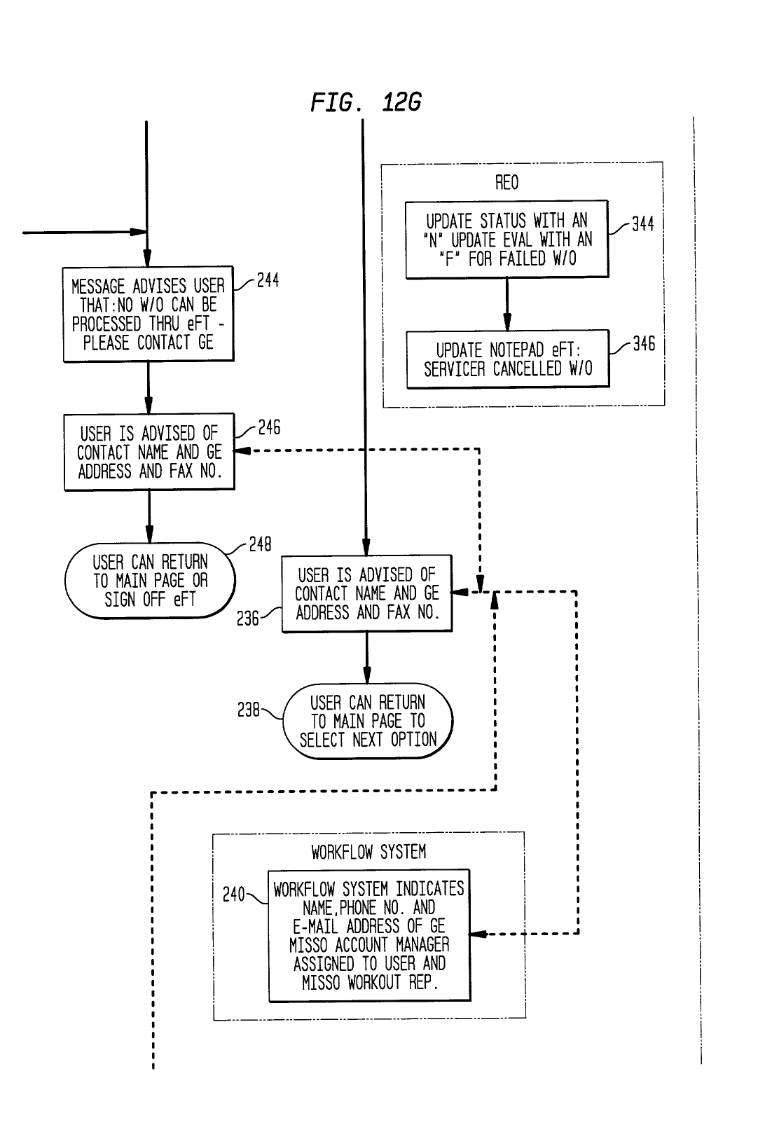

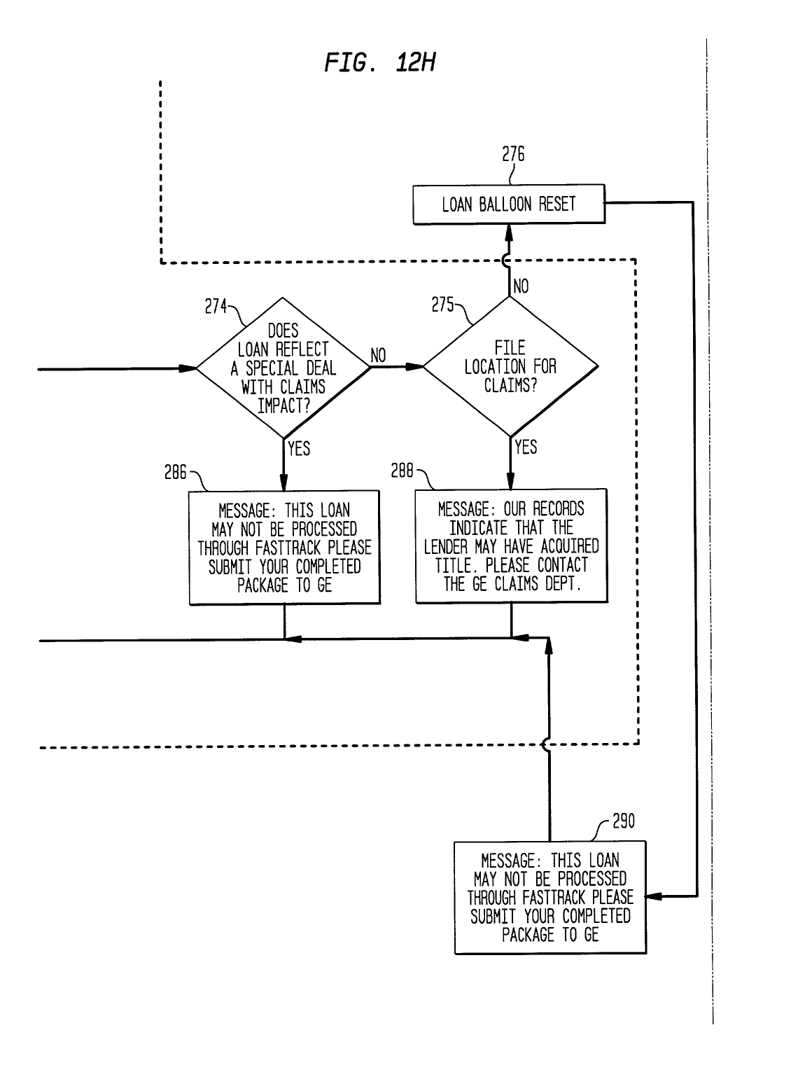

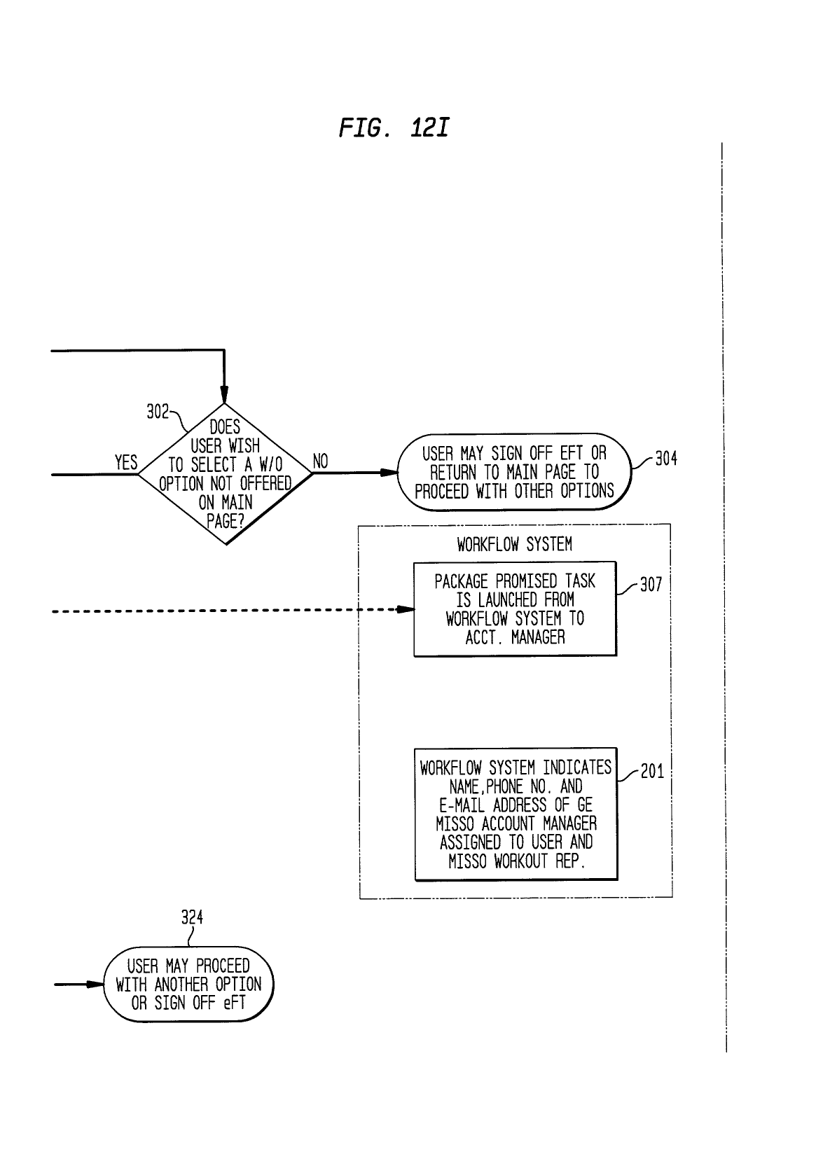

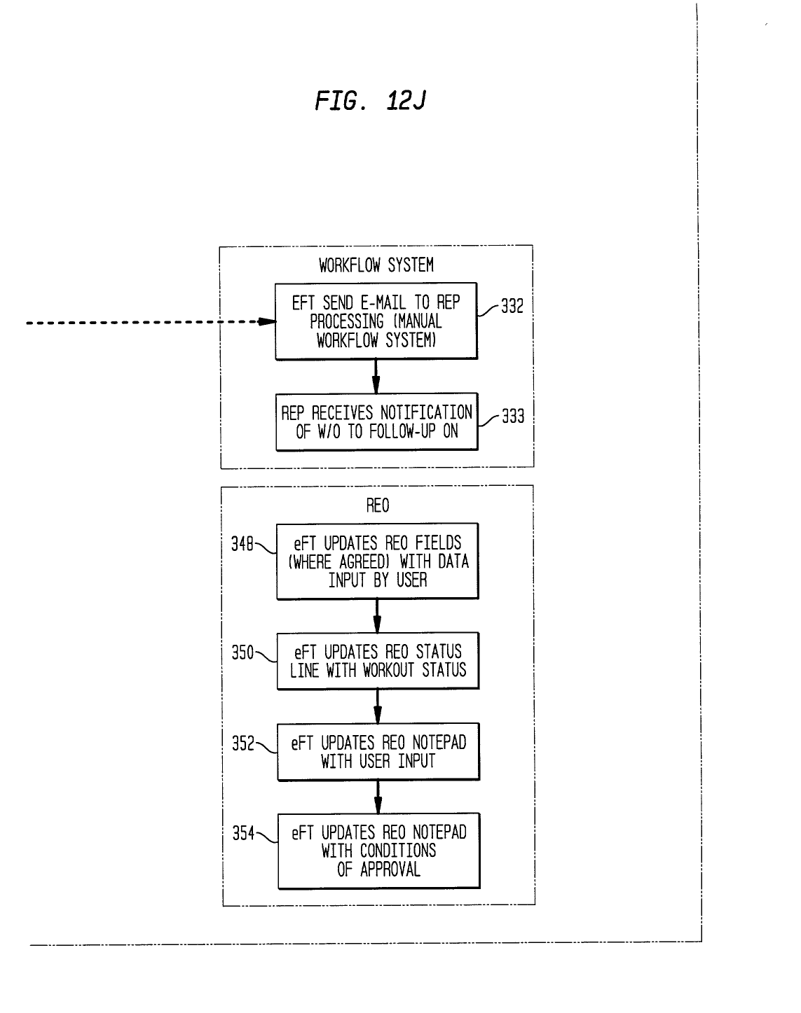

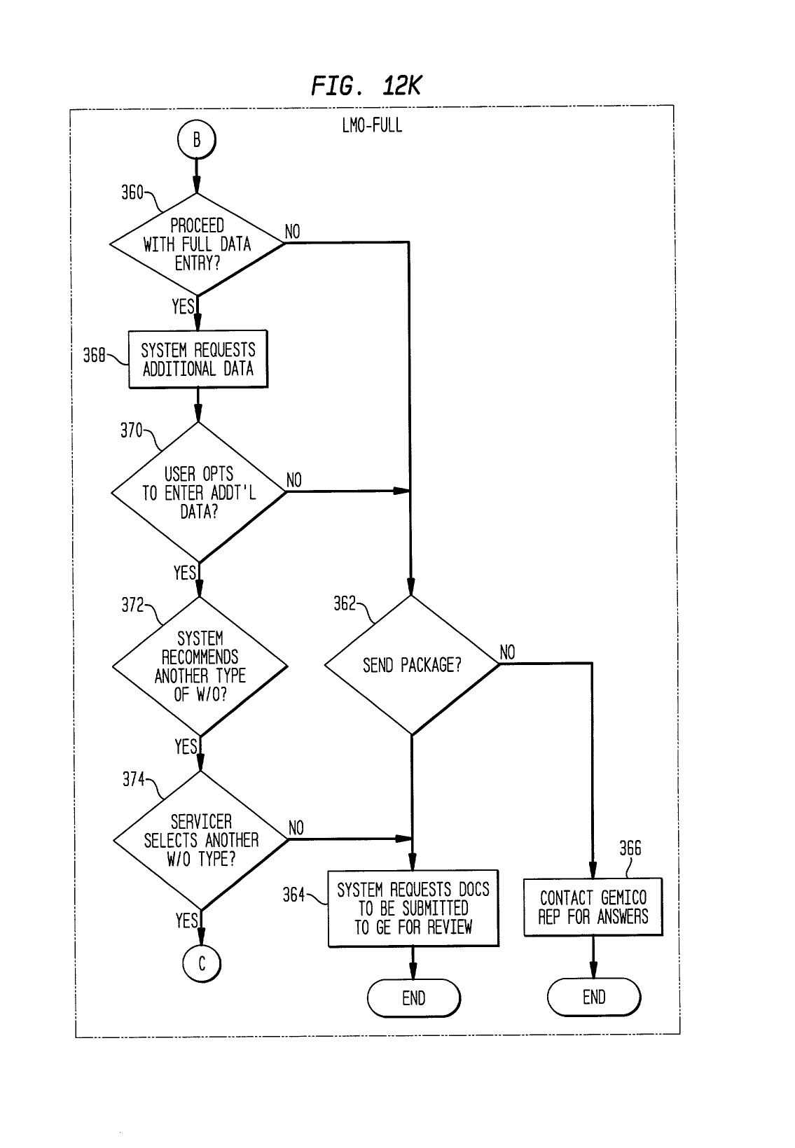

FIG. 12 shows a flowchart illustrating a method 200 according a further aspect of the present invention. Because of size considerations, FIG. 12 has been divided into a 3×5 matrix numbered FIGS. 12A1-5, 12B-15, and 12C1-5. These figures are collectively referred to as FIG. 12. As shown in FIG. 12, the method 200 includes actions performed by four systems. The e-LMO Fast Track system provides the immediate interaction with the system user. The REO system is the source of borrower and loan information, as well as workout information. The Workflow System is a task manager software package that, in a further embodiment of the invention, runs in conjunction with the e-LMO Fast Track system. Among other things, as shown in step 201, the Workflow System provides information regarding account managers and workout representatives. In addition, the Workflow System provides a scheduling and reminder function to facilitate the workout process. The LMO-Full Document Online system is an online system that provides information relating to workouts, and can be used to provide recommendations of suitable workout structures based upon user inputs. Once the recommendations have been obtained, the user may proceed either by using the e-LMO Fast Track system, assuming the e-LMO guidelines have been met, or by making a traditional document-based, hard copy submission to a workout representative.

The start of the method 200 is indicated by node A. In step 202, the user inputs the certificate number, the loan number, the investor name, and workout option and selects Go. This information can be entered, for example, on a web page such as page 90 illustrated in FIG. 5, and discussed above. This information is transmitted over the Internet or other network connection to the REO mainframe. In step 204, the REO mainframe searches the databases, using the inputted data, for borrower data and all other data needed for the workout application. In step 206, the REO mainframe advises the e-LMO Fast Track of any user mismatches.

In step 208, the system determines whether the user has inputted as an input an investor name that is not stored in the REO mainframe. If a new investor name has been entered, then in step 210, the e-LMO Fast Track system will accept the new investor name and process selections based upon edits that apply to that investor. In addition, in step 212, the investor name will be changed in the REO mainframe. In step 214, the “changed by” field in the REO mainframe will reflect the information entered into the e-LMO Fast Track system, and in step 216, the REO notepad will be updated.

In step 220, the system determines, based upon the inputted information, whether the mortgage investor is either FHLMC or FNMA-A, or some other investor program that cannot be handled by the e-LMO Fast Track System. If so, then in step 222, the user is informed that the workout is to be referred to the investor. In step 224, the user may proceed with another workout for another certificate number.

If the investor is one that allows the workout to proceed, then in step 226, the system determines whether the certificate number matches a loan stored in the mainframe. If there is no match, then in step 228, the system checks to make sure that there are ten digits in the certificate number entered. If ten digits have in fact been entered, then in step 230, the system looks to see whether the certificate number exists in another servicer's portfolio. If not, then in step 232, the system provides the following error message: “We have no record of this Certificate No. Have you entered the correct certificate number? Please contact an Account Manager for assistance. Please select the ‘Contact Us’ option.”

If in step 230 it is determined that the certificate number exists in another servicer's portfolio, then in step 234, the following message is provided: “Our records show this loan belongs to another servicer. Please contact an Account Manager for assistance. Please select the ‘Contact Us option.’ In step 236, the user is advised of the contact name and the address and fax number. In step 238, the user can return to the Main Page to select the next option. In step 240, the Workflow System indicates the name, telephone number and email address of the Account manager assigned to the user and Workout Representative.

If in step 228, it is determined that the certificate number does not have ten digits, then in step 240, a message is provided to the user advising him or her that the number should have ten digits. In step 242, the system determines whether the subsequent input results in a matching certificate. If not, then in step 244, a message advises the user that no workout can be processed through the e-LMO Fast Track. In step 246, the user is advised of the name, address, and fax number of a contact person. In step 248, the user can return to the Main Page or signoff.

Once a valid certificate number has been established, the system determines in step 250 whether a prior approved workout exists for the certificate. If so, then in step 252, the system determines whether the prior workout is in Review. If not, then in step 254 the system determines that the prior workout is Pending. The system then determines in step 256 whether the Status Change Date is greater than 60 days. If not, then the system ends the workout process for this certificate number by proceeding with steps 244-248, described above.

If the prior workout is in Review, or if the prior workout is Pending and the Status Change Date is greater than 60 days, then in step 258, the system allows the user to proceed with the workout. In step 260, the system determines whether the user wants to cancel the old workout and proceed with a new workout. If not, then in step 262, the system determines whether the user wishes to print out documents for a previously approved workout. If so, the documents are printed in step 264. In step 266, the user can return to the main page to select the next option.

The workout proceeds with step 268. In step 270 the system determines whether the loan is categorized as “Exclusionary.” If so, the loan workout may not be processed using the e-LMO Fast Track system. The system then performs a series of inquiries to determine which explanatory message to convey to the system user. These inquiries determine whether the certificate number reflects an inactive status 271, whether the lender has acquired title 272, whether the loan is pool insured 273, whether the loan reflects a special deal with claims impact 274, or whether the location of the file indicates that the lender may have acquired title 275. If the system determines that none of inquiries 271-275 apply, then in step 276, the loan is balloon reset. Steps 280-290 set forth the messages corresponding to each of steps 268-278. The workout process then terminates with step 292, in which the user is provided with contact information, and with step 294, in which the user may proceed with another option or sign off.

In step 296, the system determines whether the user has selected one of the listed workout options. If not, then in step 298, the system determines whether the user simply wishes to confirm the coverage percentage. Otherwise, in step 300, the system determines whether the user wishes to submit a full document package to a workout representative. If not, then in step 302, the system determines whether the user wishes to select a workout option not offered on the main page. If the user does not wish to select another workout option, then in step 304, the user may sign off or return to the main page to proceed with other option.

If the user wishes to pursue a workout outside of the e-LMO Fast Track, then in step 306, the user clicks on the “Submit Package” option for a workout representative to review. In step 307, the Workflow System is used to launch a “package promised” task, involving the account manager in charge of the particular certificate for which the workout is sought. In step 308, the user may sign off the system or return to the main page. If the user wishes to submit a package, the user is assisted by the Workflow system, which launches the package to the Account Manager

If it is determined in step 296 that the user has selected one of the listed workout options, then in step 310, the system provides a screen allowing for specific data entry. In step 312, the user reviews, validates and modifies data pre-filled by the system and selects the “verified” button. The user then enters data specific to the workout in step 314 and clicks on the Go button. In step 316, the system checks the REO mainframe data to see whether the workout is acceptable. If, in step 318, it is determined that the proposed workout is not acceptable, then in step 320, the user is advised of necessary changes. In step 322, it is determined whether the inputted data has been modified to meet the workout guidelines. If not, then in step 324, the workout process terminates with respect to the present certificate number, and the user may proceed with another option or sign off.

If the workout terms meet with the system guidelines, then in step 326 the system lists the conditions of approval. In step 328, the user is given the opportunity to accept or reject the conditions of approval. If the user chooses not to accept the conditions of approval, then in step 330 the user clicks on the “Cancel” button and returns to the main page. If the user accepts the conditions in step 328, then in step 332 the Workflow System is used to inform a workout representative and to track the progress of the workout. In step 333, the workout representative receives notification of the workout for followup.

In step 334, the system determines whether the user would like to receive a printed approval letter, a promissory note, or other documentation. If no printing is required, then in step 336, the user may sign off or proceed with another option. If the user wishes printed documentation, then in step 338, the system prints the documents, including the name of the workout representative and contact information. In step 340, the system determines whether the user wants to initiate a new workout on a different certificate. If not, the user may sign off in step 342. Otherwise, the system returns to node A to repeat the process.

As further shown in FIG. 12, in step 344 the REO mainframe updates, on an ongoing basis, the status and evaluation of a loan in the database. Further, in step 346, the notepad is updated if the loan servicer cancels a workout. Also, in step 348, the system updates the REO mainframe fields with data inputted by the user. In step 350, the system updates the REO mainframe status line with the workout status. In step 352, the system updates the REO mainframe notepad with data inputted by the user. And in step 354, the system updates the REO mainframe notepad with the Conditions of Approval.

As mentioned above, the e-LMO the Fast Track system works in conjunction with the LMO-Full Document Online system, which is an online system that assists a borrower to prepare a package to be submitted and reviewed by a human. In step 360, the system determines whether the user wishes to proceed with full data entry. If not, then in step 362, the system determines whether the user wishes to receive a package to be completed later. If so, then in step 364, the system requests documents to be submitted. If not, then in step 366, the user is instructed to contact the mortgage company representative for answers.

If in step 360 it is determined that the user wishes to proceed with full data entry, then in step 368, the system requests additional data. In step 370, the system determines whether the user wishes to enter additional data. If not, then the system proceeds to steps 362 and the steps which follow therefrom, which are described above. If the user wishes to enter additional data, then in step 372 the system determines whether to recommend another type of workout. If another workout type is recommended, then in step 374, the user decides whether to proceed with the other type of workout, in which case the system returns to node C, or else, if the user does not wish to proceed, the system goes to step 364.

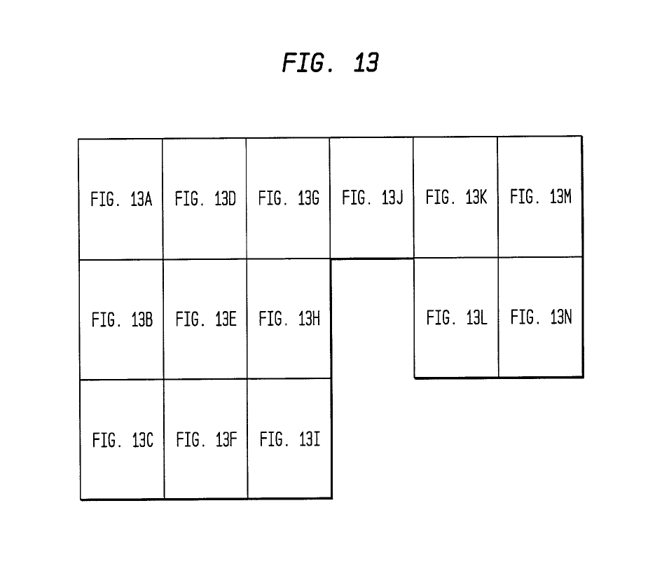

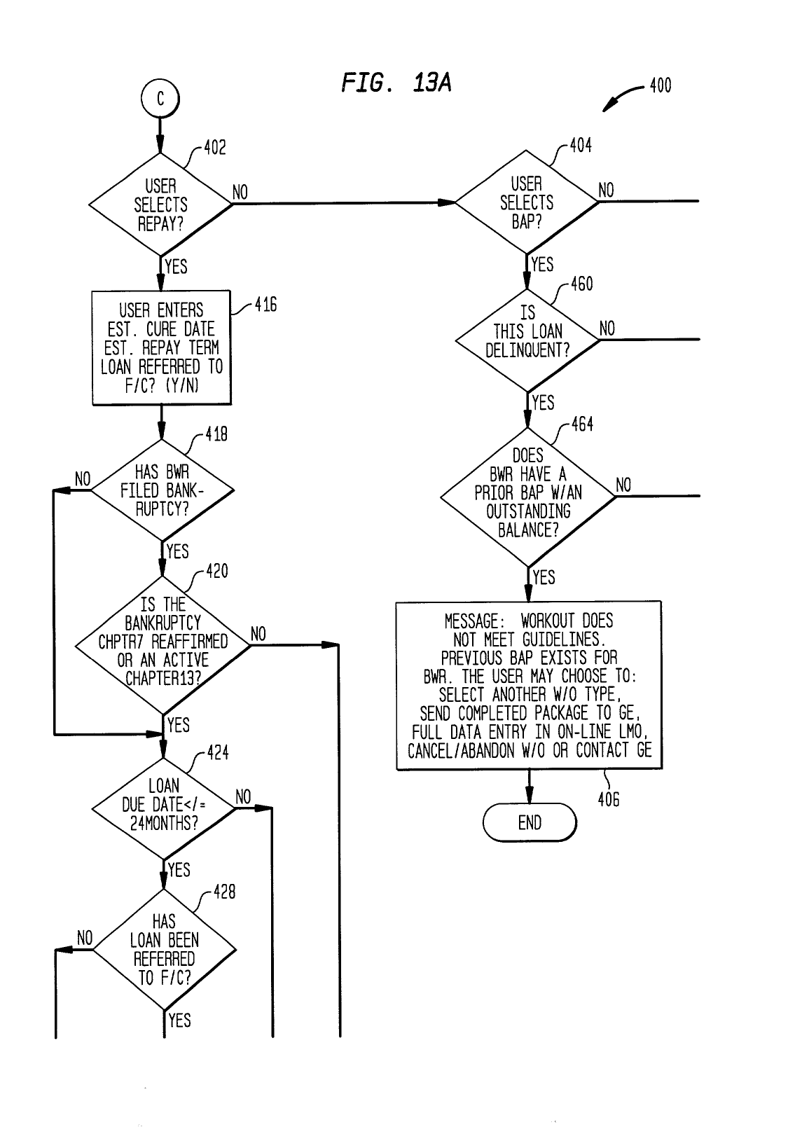

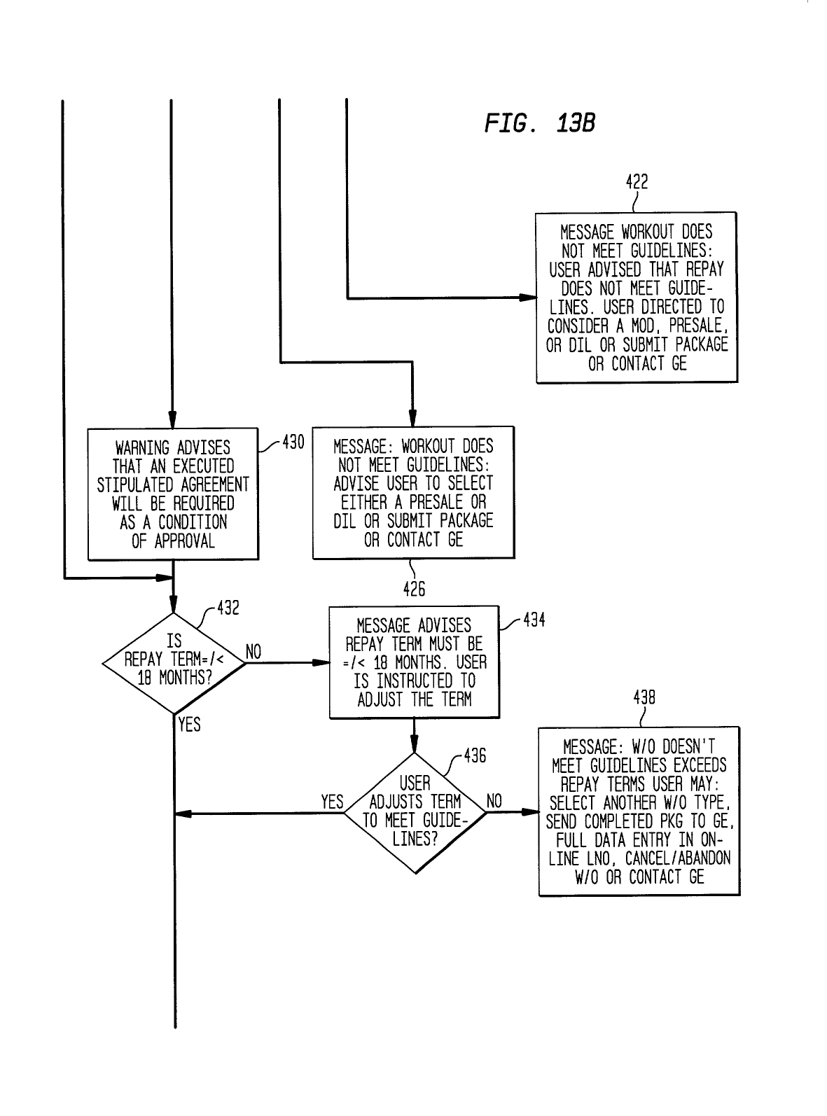

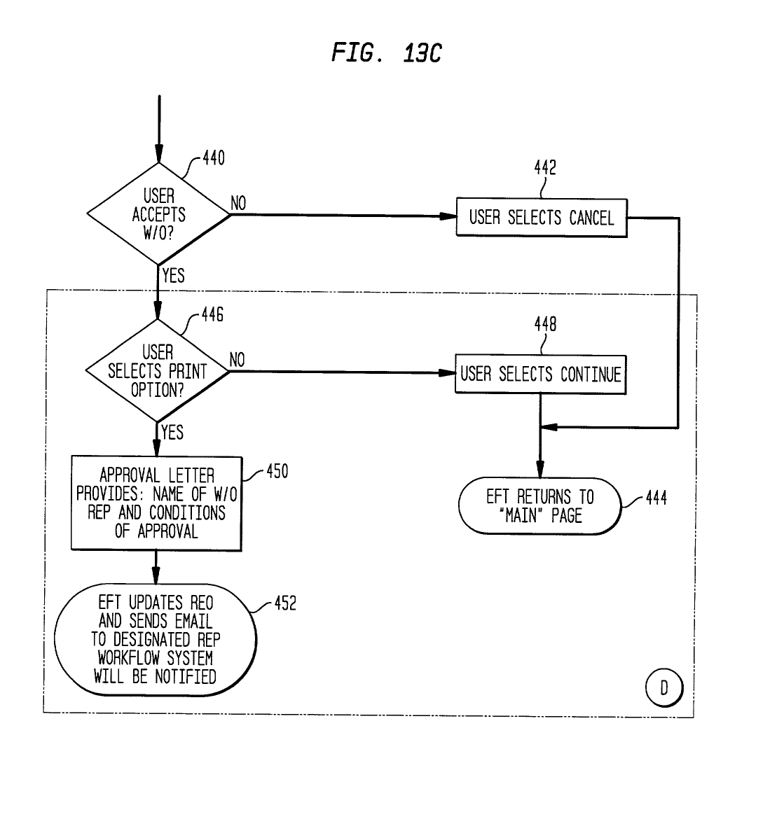

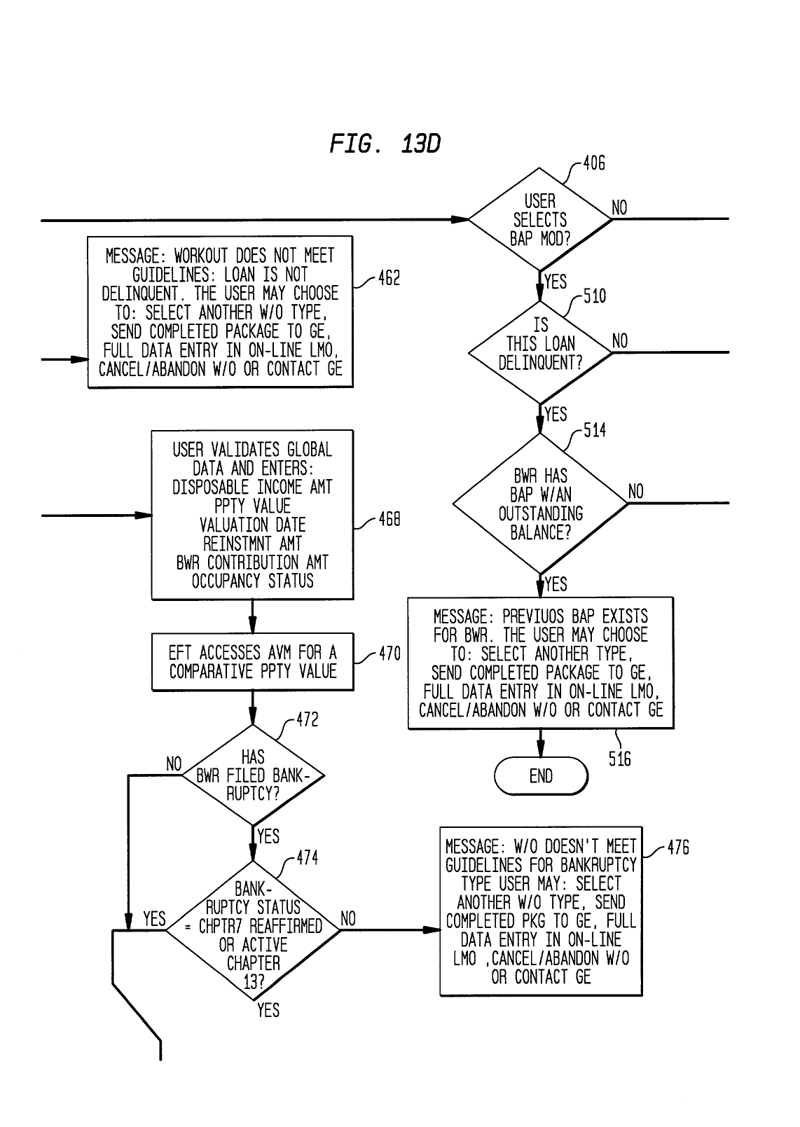

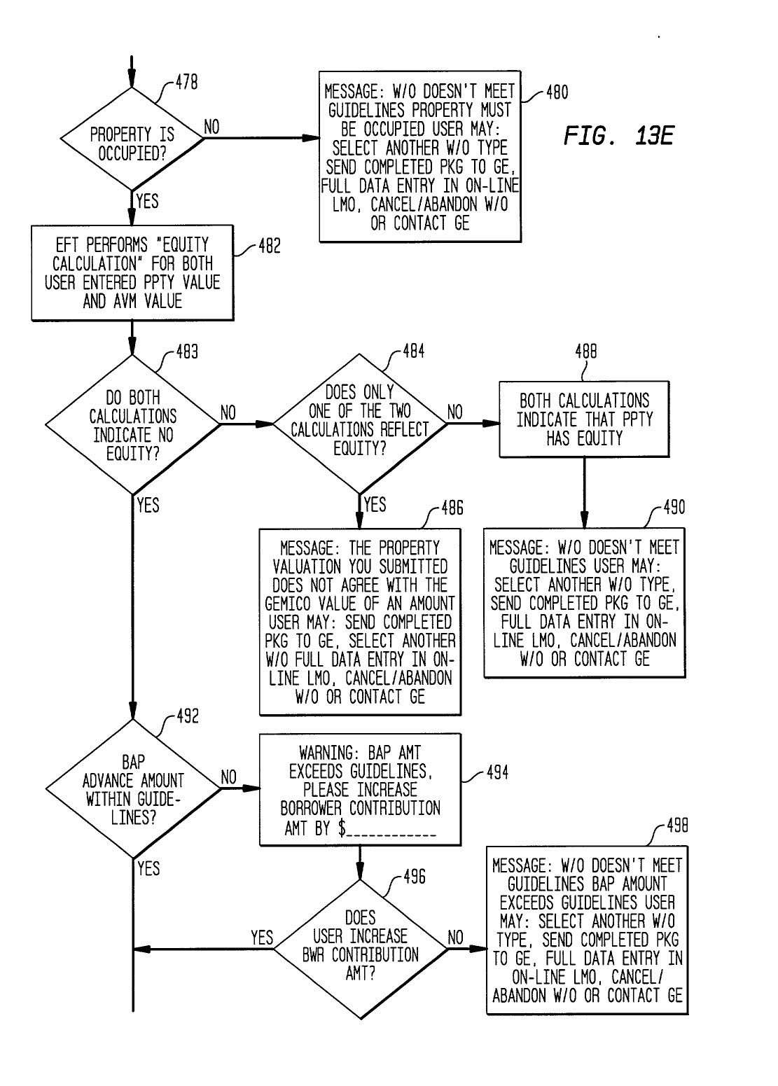

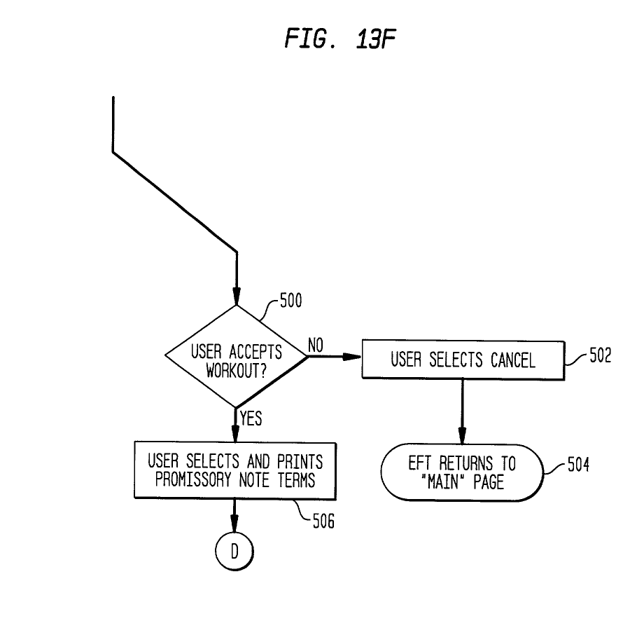

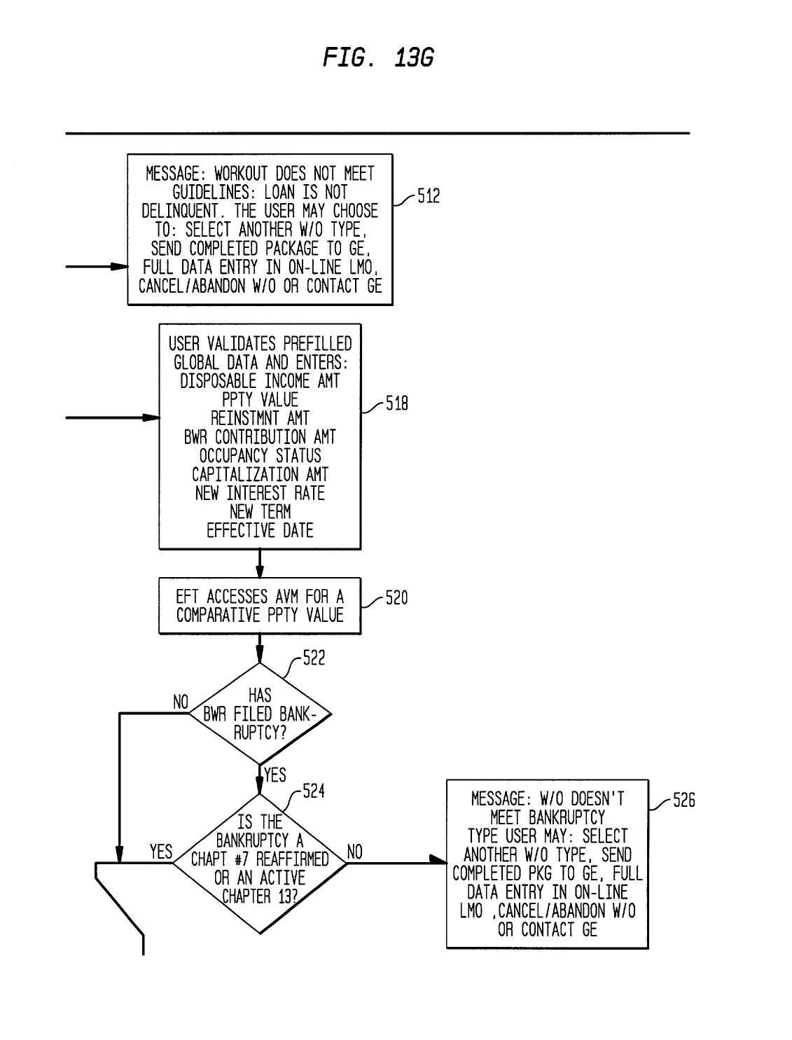

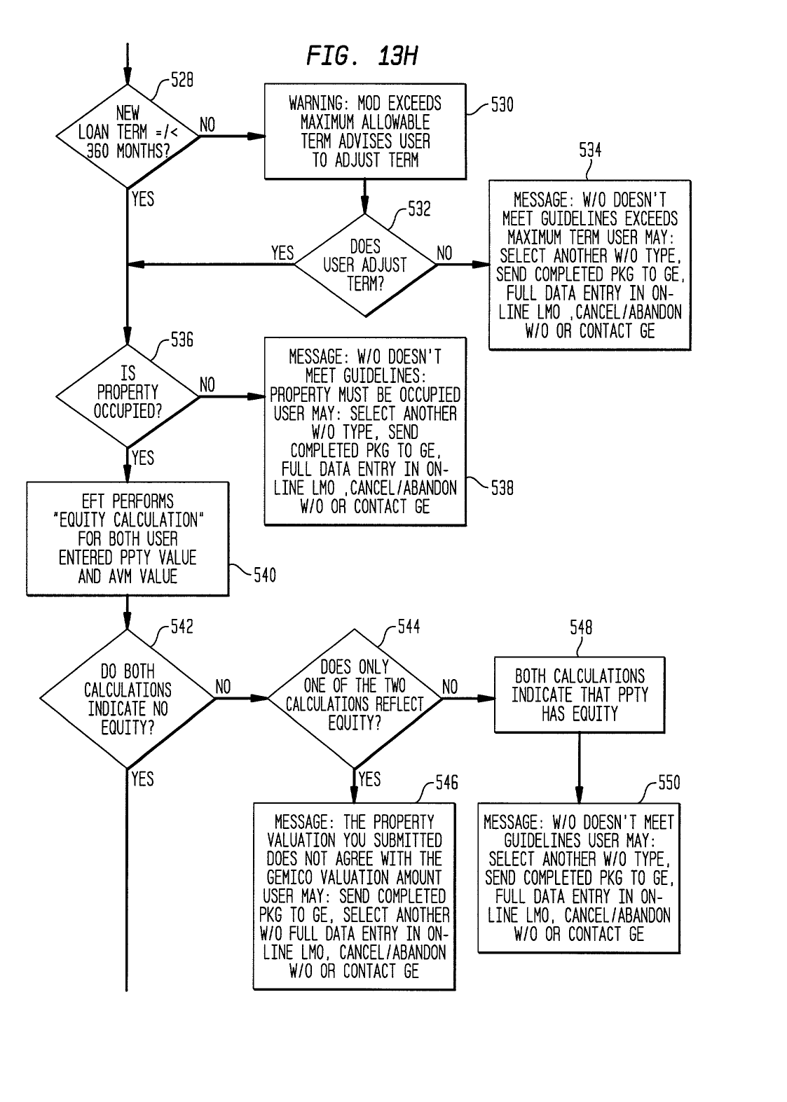

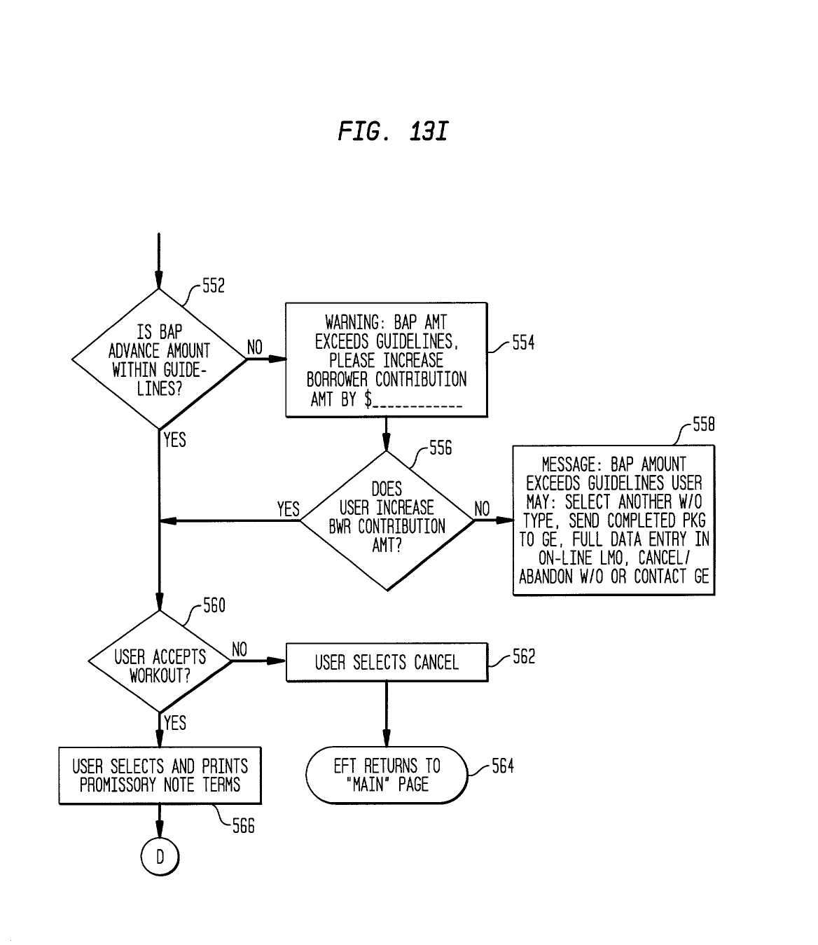

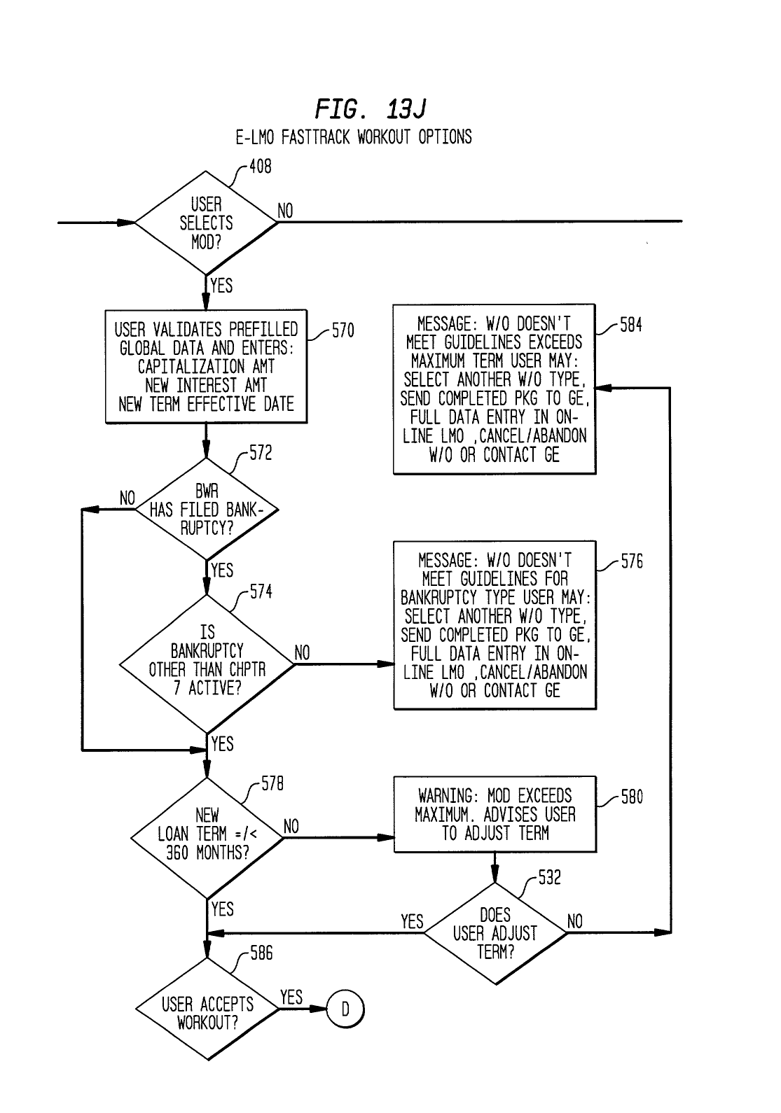

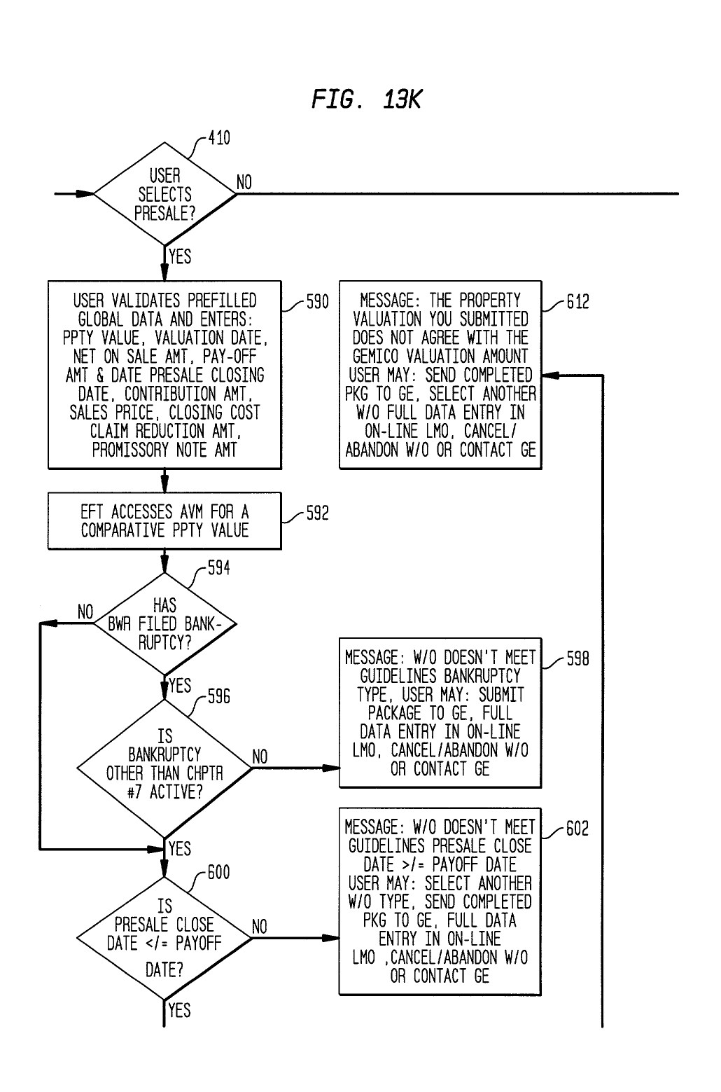

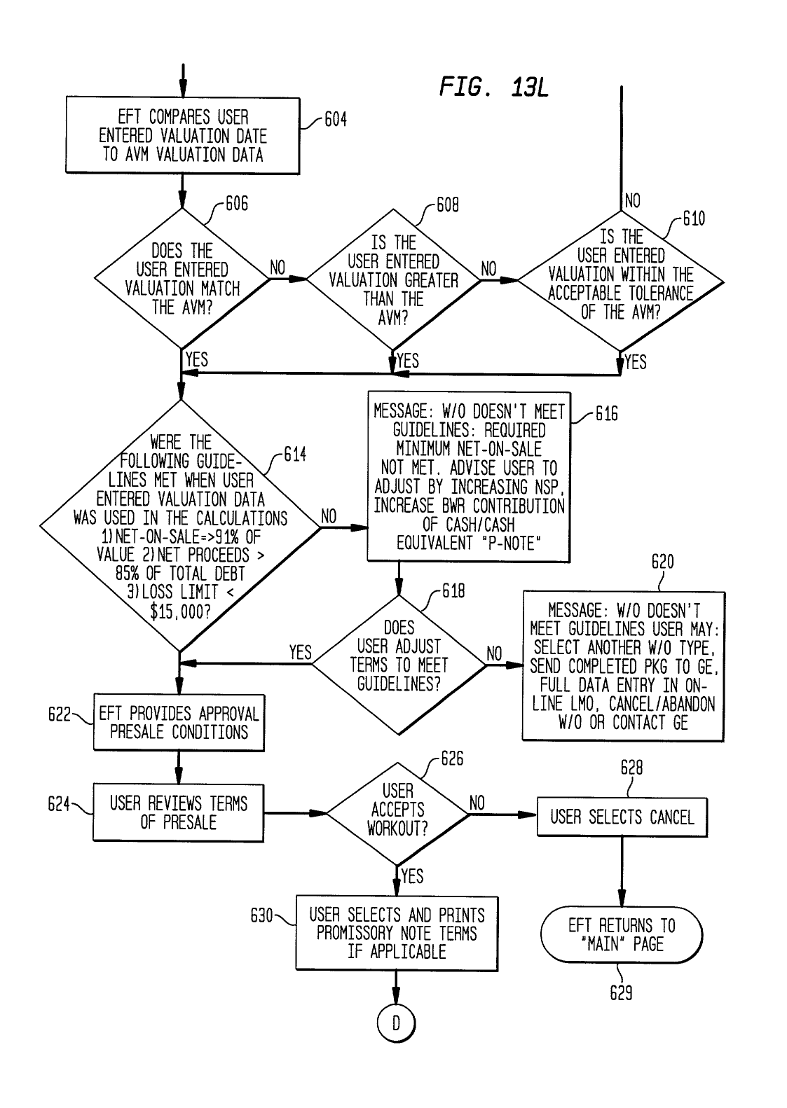

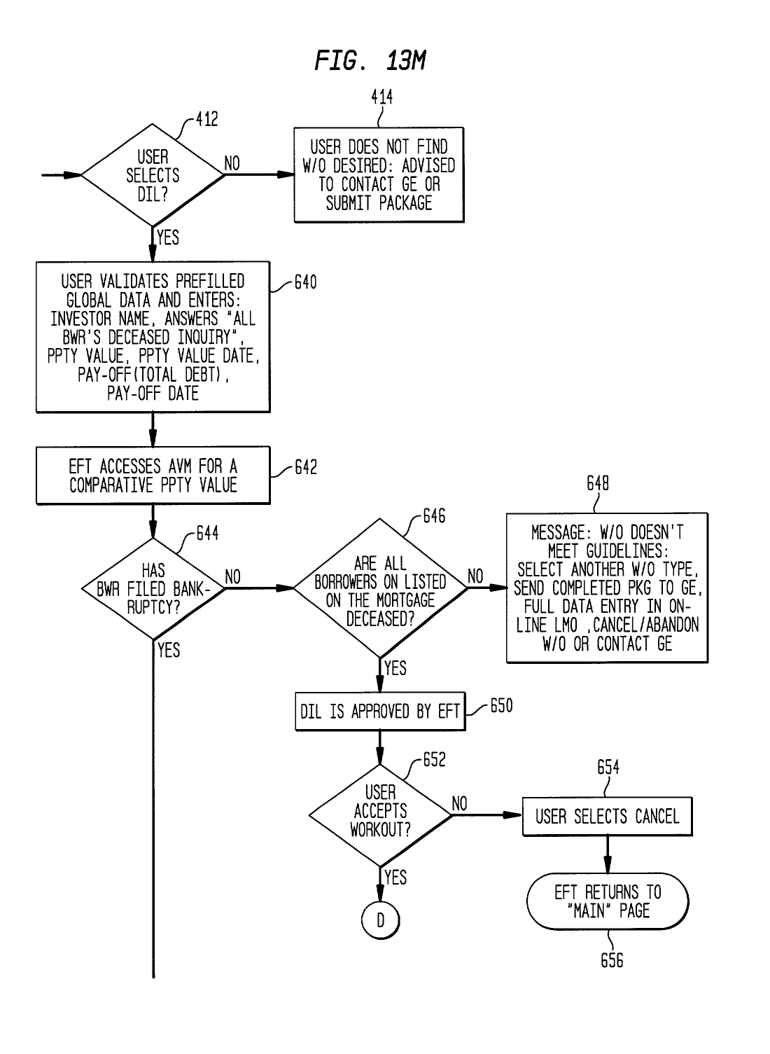

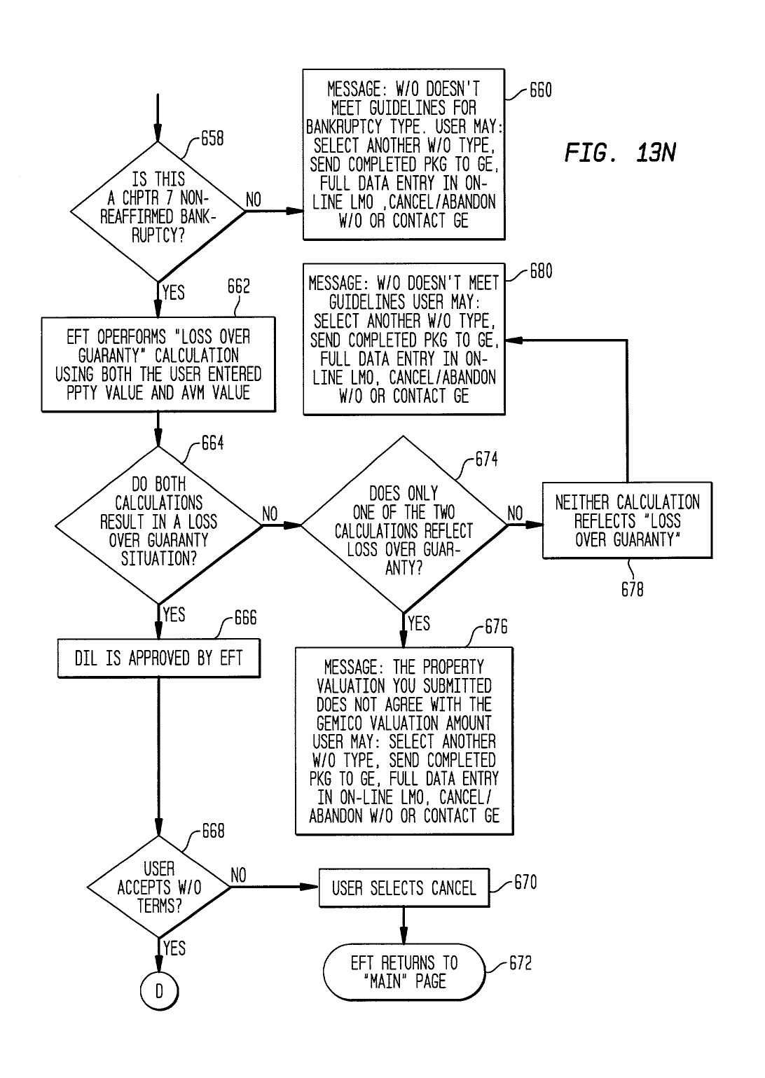

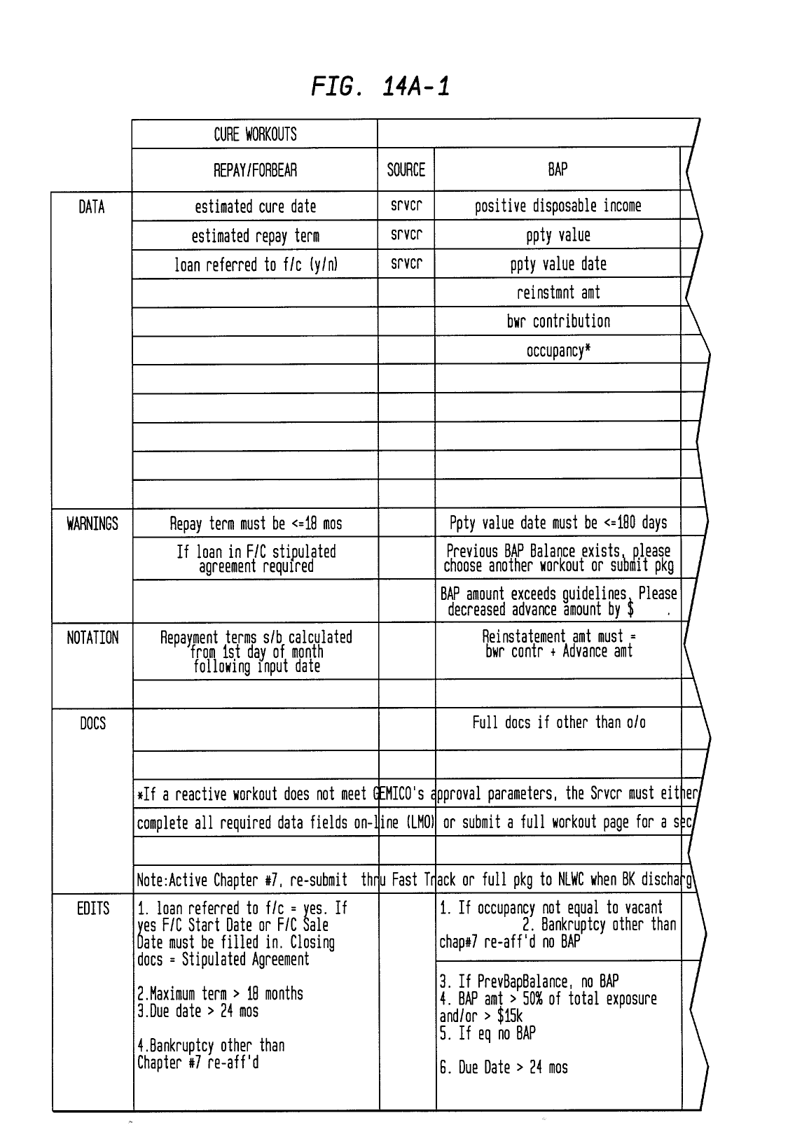

FIG. 13 is a flowchart of a method 400 according to a further aspect of the invention for handling various types of workouts. Because of size considerations, FIG. 13 has been divided into a 4×3 matrix numbered FIGS. 13A1-3, 13B1-3, 13C1-3, and 13D1-3. These figures are collectively referred to as FIG. 13. The supported workout types include: Repayment/Forbearance (“Repay”), Buyer Assistance Program (“BAP”), BAP Modification (“BAP MOD”), Loan Modification (“MOD”), Pre-Sale, or Deed-in-Lieu (“DIL”).

In steps 402-412, the system determines which one of the above types of workouts is being selected. If it is determined that the user has not found a workout option to pursue, then in step 414, the user is advised to contact the mortgage insurance company for more information, or to submit a full document package for review by an account manager. The steps involved for each of the above listed types of workouts are described below.

### Repayment/Forbearance (“Repay”)

As mentioned above, in a repay scenario, the borrower is experiencing a financial hardship that is perceived to be temporary. The borrower typically has missed a few loan payments, but wishes to resume making the original payments on the loan, plus make arrangements to pay the delinquent amount.

The Repay workout decision process begins in step 416, in which the user enters the estimated cure date, the estimated repayment term, and whether the loan has been referred to foreclosure. Steps 418-422 are used to ascertain the borrower's bankruptcy status. If the borrower has filed for bankruptcy, the borrower may nonetheless be eligible to use the e-LMO Fast Track system if it is determined that the bankruptcy is either a Chapter 7 bankruptcy in which the borrower has reaffirms his or her obligations under the loan for which a workout is sought, or if the bankruptcy is an active Chapter 13 bankruptcy. If the borrower is ineligible to use the e-LMO system, then in step 422, a suitable message is conveyed to the system user.

In step 424, the system determines whether more than 24 months have elapsed since the Loan Due Date. If more than 24 months have elapsed, then in step 426, the system provides the message that the workout cannot be handled by Fast Track. If, however, less than 24 months have elapsed, then in step 428, the system determines whether the loan has been referred to foreclosure. If so, then in step 430, the system advises the user that an executed stipulated agreement will be required as a condition of approval.

In step 432, the system determines whether the term for the repayment of the delinquent amount is less than or equal to 18 months. If the term is greater than 18 months, then in step 434, the user is advised that the term cannot exceed 18 months. In step 436, the system determines whether the user has adjusted the term to meet the guidelines. If the term still does not meet the guidelines, then a suitable message is provided to the user in step 438.

Otherwise, in step 440, the system determines whether the user accepts the workout. If not, then in step 442 the user selects “cancel,” and in step 444 the system returns to the home page. If the user accepts the workout, then in step 446, the user is given the option of printing out documents. If no printout is requested, the user clicks on a “continue” button in step 448 and the process terminates with step 444, in which the user is returned to the home page. If the user requests printed documents, the documents are printed out in step 450. The approval letter includes the name of the workout representative and conditions of approval for the workout. In step 452, the system updates the loan information in the mainframe and sends email to a designated representative. The Workflow System is also notified. Steps 444-452 are collectively referred to hereinafter as “block D.”

### Borrower Assistance Program (“BAP”)

As described above, a Borrower Assistance Program is used when the borrower has a short-term financial crisis, expects to be able to return to the original payment schedule, but needs an additional accommodation to make the delinquent payments. As part of a BAP, the Borrower signs a promissory note to guarantee payment of the delinquent fees.

In considering a BAP, the system first determines in step 460 whether the loan is delinquent. If not, then the situation does not meet the guidelines of the e-LMO Fast Track system, and in step 462 a suitable message is sent to the user. If the loan is delinquent, then the system determines in step 464 whether the borrower has a prior BAP with an outstanding balance. If so, then the situation does not meet the Fast Track guidelines, then in step 466 a suitable message is conveyed to the user, and the workout process is terminated.

In step 468, the user validates global pre-filled data on the data input screen and, in addition, enters the amount of his or her disposable income, the value of the property, the date of property valuation, the reinstatement amount, the amount of borrower contribution, and the occupancy status of the property. In step 470, according to a further embodiment of the invention, the system uses an Automated Value of Market (“AVM”) system to determine the value of the property. As discussed below, the AVM value is compared with the property value entered by the borrower to insure that the borrower has not entered an unrealistic estimate of the value of the property secured by the loan.

Steps 472-476 are then used to ascertain the bankruptcy status of the borrower, and correspond to steps 418-422 described above.

In step 478, the system determines whether the property is occupied. The system defines a property as being occupied if the property is occupied by the owner, occupied by the owner and a tenant, occupied by a tenant, or currently vacant but scheduled to be occupied within 90 days. If the property is not occupied, then in step 480 a suitable message is conveyed informing the user that the e-LMO Fast Track may not be used for the present workout.

In step 482, the system performs an equity calculation, based upon the property value entered by the user and the AVM value to determine whether there is any equity in the property. It will be recalled that one requirement for a BAP is that there is no equity. If at least one of the valuations indicates that there is some equity in the property, then the e-LMO Fast Track system may not be used. Steps 484-490 are used to provide a suitable message to the user informing him or her of the results of the equity calculation and further informing the user that the e-LMO Fast Track system may not be used.

In step 492, the system determines whether the proposed BAP advance amount is within predetermined guidelines. If not, then in step 494, the system asks the user to increase the amount of the borrower contribution by a certain number of dollars. If in step 496 it is determined that the user has failed to suitably increase the amount of the contribution, then in step 498, a suitable message is conveyed to the user.

Assuming that the contribution is determined to be adequate, then in step 500, it is determined whether the user accepts the terms of the workout. If not, then in step 502 the user selects “cancel” and in step 504 the system returns to the main page. If the user accepts the terms of the workout, then in step 506 the user selects and prints the promissory note. The system then proceeds to block D for completion of the workout process.

### Modification to Buyer Assistance Program (“BAP MOD”)

This is the option chosen when the borrower has already entered into a BAP, but needs to modify it because the financial situation has not developed as anticipated. The system first determines in step 510 whether the loan is delinquent. If not, then in step 512 a suitable message is sent to the user and the process terminates. In step 514, it is determined whether the borrower has a prior BAP with an outstanding balance. If so, then in step 516 the user is informed by a suitable message that the loan is ineligible for processing using the e-LMO system and the process terminates.

If it is determined that the BAP MOD process may continue, then in step 518, the user validates pre-filled global data on a suitable data entry screen and enters the following further data: the amount of disposable income, the value of the property, the reinstatement amount, the borrower contribution value, the occupancy status, the capitalization amount, the new interest rate, the new term, and the effective date. In step 520, the system obtains an AVM value for comparison with the value entered by the borrower.

Steps 522-526 determine whether the borrower's bankruptcy status makes the loan ineligible for processing using the e-LMO Fast Track system.

In step 528, the system determines whether the new loan term is less than or equal to 360 months. If the new loan term exceeds 360 months, then in step 530 the user is warned that the term exceeds the maximum and advises the user to adjust the term. If in step 532 it is determined that the term has not been suitably adjusted, then in step 534, a suitable message is conveyed to the user, informing him or her that the loan may not be processed using the e-LMO Fast Track system.

Steps 536 and 538 are used to determine the occupancy status of the property, and steps 540-550 are used to perform an equity calculation. These steps correspond to steps 478-490, described above. The remaining steps 552-566 correspond to steps 492-506 described above. Again, if the user agrees to the workout conditions, the process concludes by returning to block D.

### Loan Modification (“MOD”)

The MOD option is for situations in which the borrower's financial hardship is long-term, affecting the borrower's ability to continue to meet his or her obligations under the original loan agreement. In step 570, the user validates pre-filled global data and enters the following additional information: the capitalization amount, the new interest rate, and the new term effective date. Steps 572-576 are used to ascertain the borrower's bankruptcy status and whether that status affects the borrower's eligibility to use the e-LMO Fast Track system. Steps 578-584 insure that the loan term is 360 months or shorter. If in step 586 the borrower accepts the conditions of the workout, then the process moves to block D for completion.

### Pre-Sale

If the borrower's financial hardship is such that the borrower is unable to continue to own the property, the borrower may select the “pre-sale” option, in which the workout representatives work with the borrower to assist in marketing the property. The estimated proceeds from the sale of the property are used in arriving at suitable terms for the workout.

In step 590, the user validates pre-filled global data and enters the following additional information: the property value, the valuation date, the net on-sale amount, the payoff amount and date, the pre-sale closing date, the contribution amount, the sales price, the closing costs, the claim reduction amount, and the promissory note amount. In step 592, the system obtains an AVM value for the property. Steps 594-598 are used to ascertain the borrower's bankruptcy status and whether, if the borrower has filed for bankruptcy, the borrower is still eligible to use the e-LMO Fast Track system.

In step 600, the system determines whether the Pre-Sale closing date is sooner than the payoff date. If not, then in step 602, a suitable message is sent to the user informing the user that the loan may not be processed using the e-LMO system.

In step 604, the system compares the property value entered by the borrower with the AVM value. If in steps 606 or 608 it is determined that the entered value matches or exceeds the AVM value, the system proceeds to step 614. The system also proceeds to step 614 if it is determined in step 610 that the user entered valuation falls with an acceptable tolerance. If none of the conditions set forth in steps 606-610 are met, then in step 612 a suitable message is sent to the user informing the user that the loan may not be processed using the e-LMO system.

In step 614, the system considers whether the User Entered Valuation Data meets the following guidelines: net-on-sale is at least 91% of the value, the net proceeds of the sale is at least 85% of the debt, and the loss limit is less than $15,000. If not, then the user is informed of this fact in step 616 and given the opportunity to adjust the terms of the proposed workout. If in step 618 it is determined that the proposed workout still does not meet the guidelines, then in step 620, a suitable message is sent to the user informing the user that the e-LMO system may not be used for the present workout.

In step 622, the system provides the Conditions of Approval for the proposed workout. In step 624, the user reviews the terms of the pre-sale. In step 626, it is determined whether the user accepts the Conditions of Approval. If not, then in step 628 the user selects cancel, and in step 629 the system returns to the e-LMO home page. If the user accepts the Conditions of Approval, then in step 630 the user selects and prints promissory note terms, if applicable. The workout process then concludes by moving to block D.

### Deed-in-Lieu (“DIL”)

The final option is the Deed-in-Lieu or “DIL,” in which the borrower proposes to deed the property over to the bank, towards the satisfaction of the loan obligations. In step 640, the user validates the pre-filled global data and enters the following further information: the name of the investor, an answer to a query as to whether all of the borrowers are deceased, the property value, the property valuation date, the payoff amount (i.e., the total debt), and the payoff date. In step 642, the system obtains an AVM value for the property.

In step 644, the system determines whether the borrower has filed for bankruptcy. If not, in step 646 the system determines whether all of the borrowers listed in the mortgage are deceased. If not, then in step 648 the user is informed that the workout may not be processed using the e-LMO system. If the borrowers are in fact deceased, then in step 650, the DIL is approved by the system. In step 652, it is determined whether the user accepts the workout terms. If not, then in step 654 the user selects “Cancel” and in step 656 the system returns to the e-LMO home page. If the user accepts the workout terms, then the system proceeds to block D.

If in step 644 it is determined that the borrower has filed for bankruptcy, then in step 658, it is determined whether the bankruptcy filing is a non-reaffirmed Chapter 7 filing. If not, then in step 660 the user is informed by a suitable message that the workout may not be processed using the e-LMO system. If the filing is a non-reaffirmed Chapter 7, then in step 662 the system performs a “Loss over Guaranty” calculation using the borrower-entered valuation and the AVM value. In step 664, it is determined whether both calculations result in a Loss over Guaranty situation. If so, the DIL is approved by the system in step 666. In step 668 it is determined whether the user accepts the workout terms. If not, then in step 670 the user selects “Cancel” and in step 672 the system returns to the e-LMO home page. If the user accepts the workout terms, then the process concludes by moving to block D.

If in step 664 it is determined that one or both calculations fail to result in a Loss over Guaranty situation, then the loan may not be processed using the e-LMO system. In this case, steps 674-680 are used to determine which message is to be conveyed to the user.

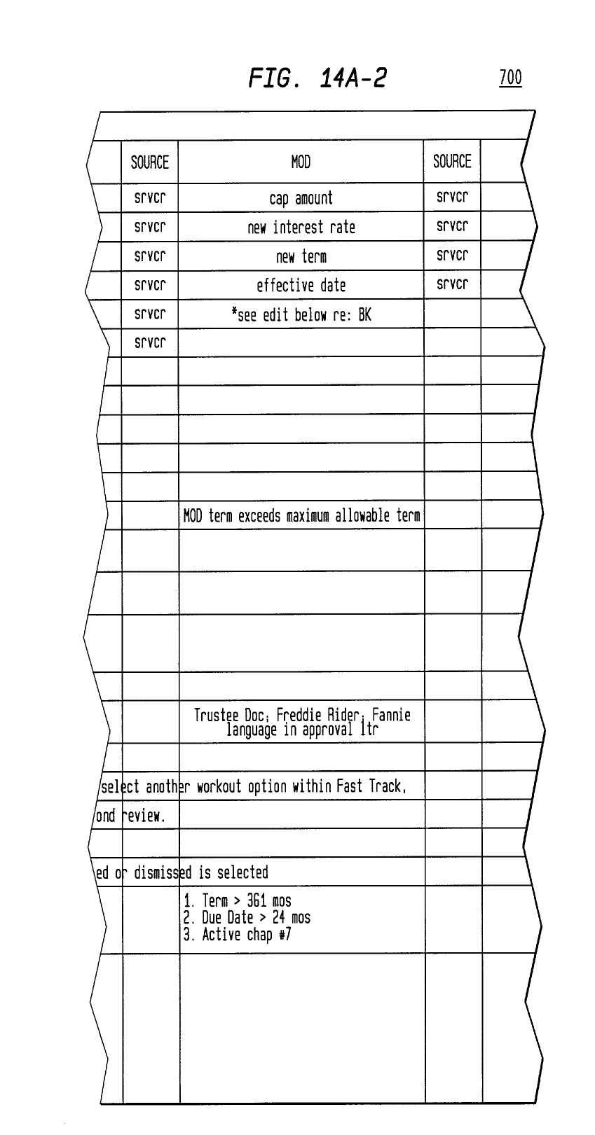

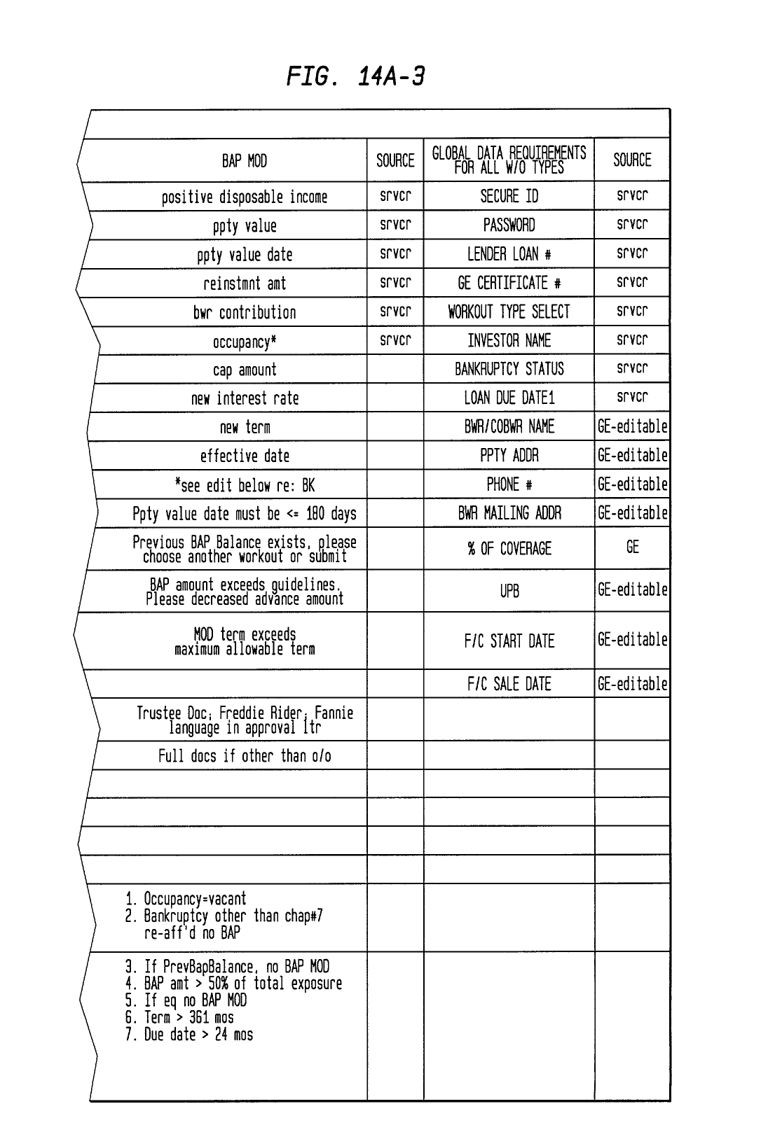

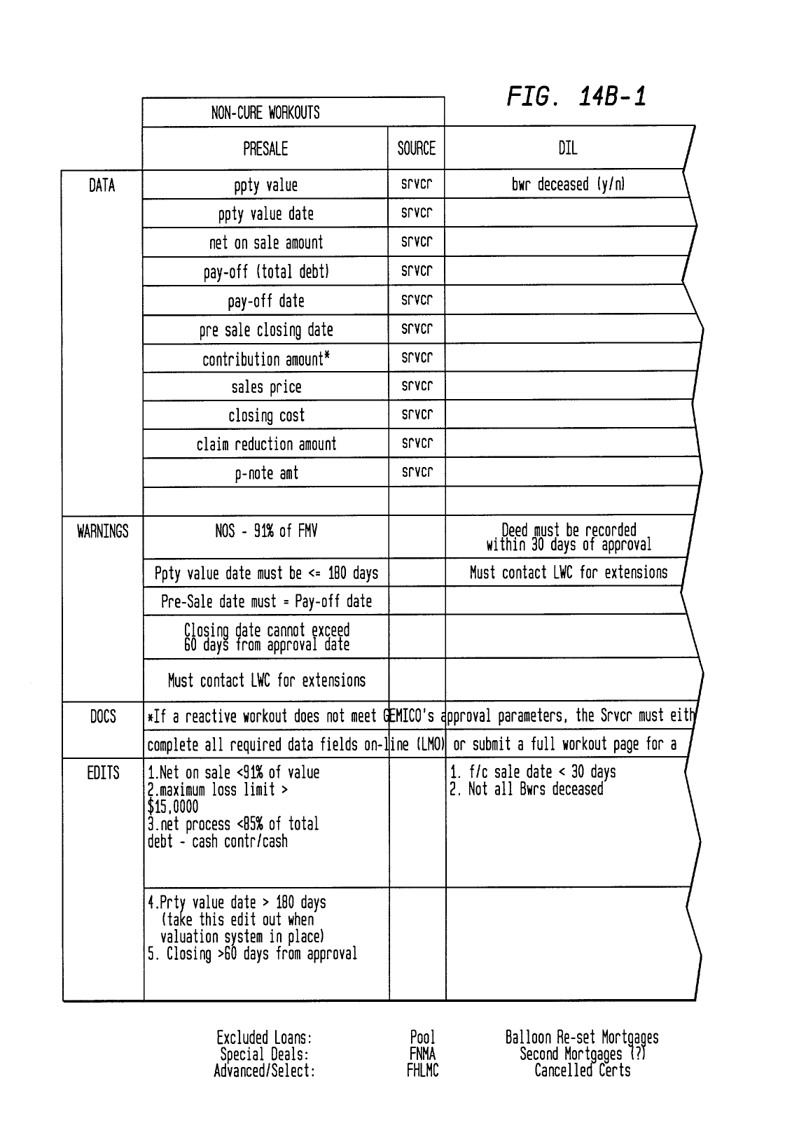

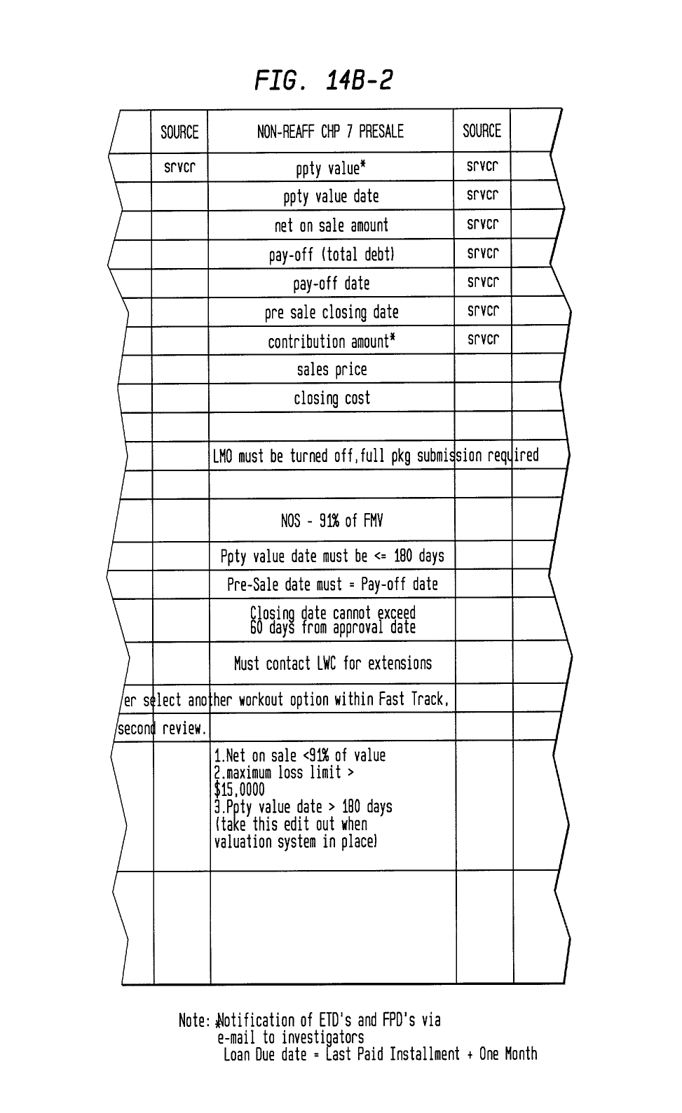

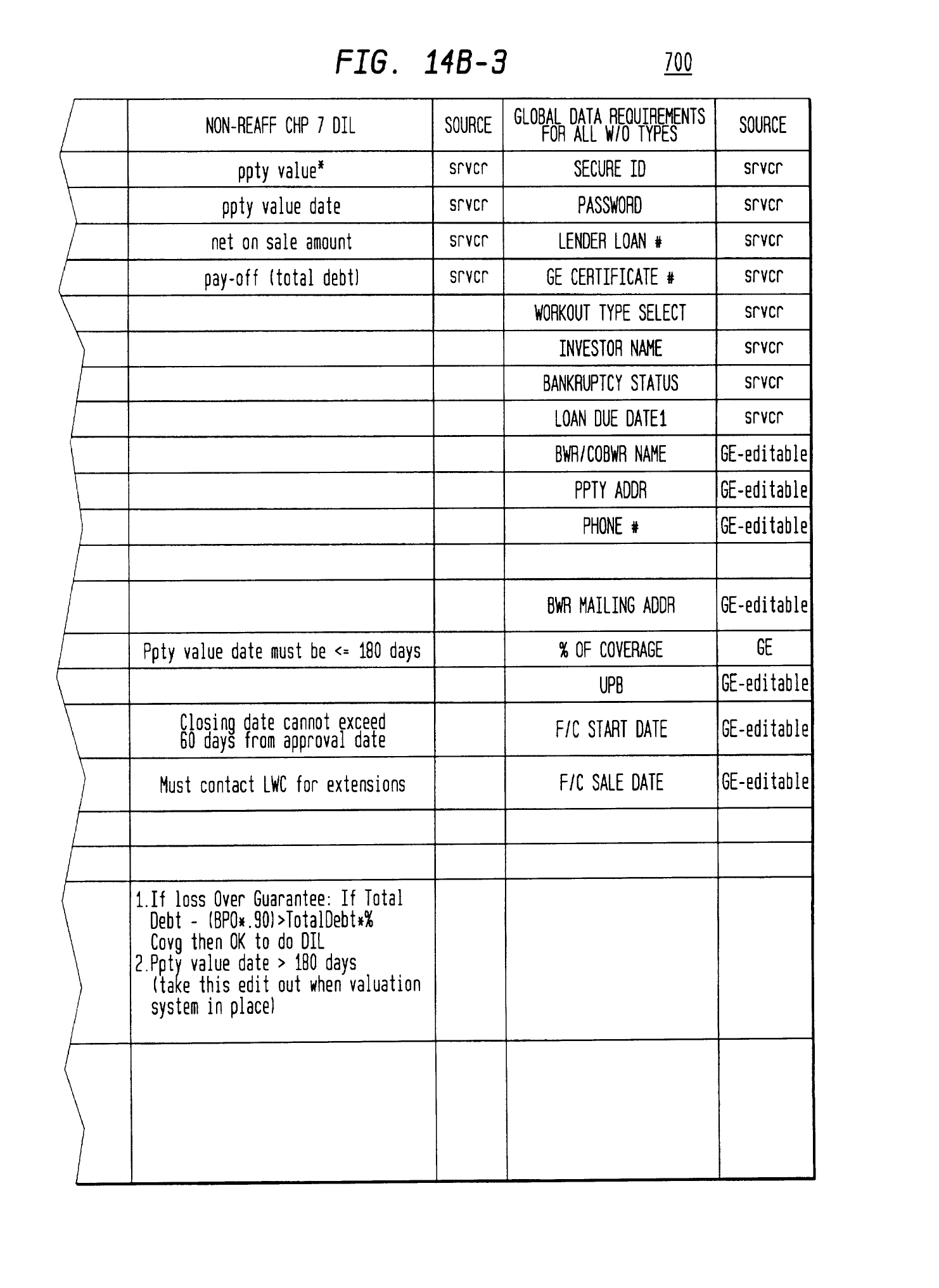

FIGS. 14A and 14B set forth a data matrix 700 that illustrates the data inputs required for the various workouts handles by the e-LMO system and other information relating to the processing these data inputs in accordance with the present invention.

A Computer Program Listing Appendix is provided with the present application, incorporated herein by reference, that contains exemplary pseudo-code illustrating an implementation of the various forms and functions described above. This pseudo-code can be readily translated into any suitable programming language including, for example, Microsoft Visual Basic. The pseudo-code is provided as an example of one approach to implementing the various forms and functions and may be modified, as needed, without departing from the spirit of the present invention. It should be noted that the Appendix may reflect modifications of the methods illustrated in the flowcharts shown in FIGS. 12 and 13.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A system for automatically obtaining loan workout decisions, comprising:
a network of personal computers connected into a network administered by a central server computer,
each personal computer in the network including a network interface for transmitting borrower inputs to, and receiving outputs from, the server computer,
each personal computer in the network further including display screens for receiving inputs from, and providing outputs to, a financially troubled borrower, including inputs and outputs relating to a proposed workout,
the central server computer having a central processing unit that runs automatic workout decision analysis software and has access to electronically stored information relating to the financially troubled borrower and other information necessary to the decision analysis process,
the central server computer transmitting to the financially troubled borrower, automatically over the network, approval of the proposed workout if certain predefined parameters are met and, if the predefined parameters are not met, providing further instructions to the financially troubled borrower.

2. The system of claim 1, wherein the personal computers are connected into the network using an Internet connection.

3. The system of claim 1, wherein the network interface is web-based.

4. The system of claim 1, wherein the user selects a workout type among a menu of predefined workout types.

5. The system of claim 1, wherein if the user inputs fail to satisfy predetermined guidelines, the user receives a message informing the user that the system cannot be used.

6. A method for automatically obtaining loan workout decisions, comprising:
connecting a network of personal computers connected into a network administered by a central server computer;
providing each personal computer in the network with a network interface for transmitting borrower inputs to, and receiving outputs from, the server computer;
displaying on each personal computer in the network screens for receiving inputs from, and providing outputs to, a financially troubled borrower, including inputs and outputs relating to a proposed workout;
running automatic workout decision analysis software having access to electronically stored information relating to the financially troubled borrower and other information necessary to the decision analysis process;
transmitting to the financially troubled borrower, automatically over the network, approval of the proposed workout if certain predefined parameters are mettions to the financially troubled borrower.

7. The method of claim 6, further including:
connecting the personal computers into the network using an Internet connection.

8. The method of claim 6, further including:
using a web-based interface for connecting the server computer into the network.

9. The method of claim 6, further including:
system of claim 1, wherein the user selects a workout type among a menu of predefined workout types.

10. The method of claim 6, further including:
transmitting a message informing the user that the system cannot be used if the user inputs fail to satisfy predetermined guidelines.
